(19) United States
(12) Patent Application Publication
(10) Pub. No.: US 2016/0378922 A1
(43) Pub. Date: Dec. 29, 2016

(54) METHODS AND APPARATUSES FOR ELECTRONICALLY DOCUMENTING A VISIT OF A PATIENT

(71) Applicant: Patrick Shiu, Vancouver (CA)

(72) Inventor: Patrick Shiu, Vancouver (CA)

(21) Appl. No.: 15/196,780

(22) Filed: Jun. 29, 2016

Related U.S. Application Data
(60) Provisional application No. 62/185,901, filed on Jun. 29, 2015.

(51) Int. Cl. G06F 19/00

(52) U.S. Cl. CPC G06F 19/322; G06F 19/325; G06F 19/328; G06F 19/363

(57) ABSTRACT

A method of electronically documenting a visit of a patient involves causing at least one computer to: in response to at least one assessment code input signal, retrieve, from at least one computer-readable medium, a first plurality of previously entered patient chart entries stored on the at least one computer-readable medium in association with the assessment code; display at least some of the first plurality of previously entered patient chart entries for user selection; receive at least one selection input signal representing user selection of at least one selected patient chart entry of the first plurality of previously entered patient chart entries; and in response to the at least one selection input signal, store the at least one selected patient chart entry on the at least one computer-readable medium in association with the visit. Apparatuses also disclosed.

### CROSS-REFERENCE TO RELATED APPLICATION

This application claims the benefit of U.S. provisional patent application No. 62/185,901 filed Jun. 29, 2015, the entire contents of which are incorporated by reference herein.

### FIELD

This disclosure relates generally to electronically documenting a visit of a patient.

### RELATED ART

Many medical healthcare professionals use electronic or computerized methods of documenting visits of patients, but existing methods of electronically documenting a visit of a patient are complex, inefficient, and unintuitive for some medical practices. Accordingly, existing methods of electronically documenting a visit of a patient may be time-consuming, and time spent charting according to existing methods of electronically documenting a visit may diminish the amount of time that healthcare professionals can spend assisting patients in patient visits.

### SUMMARY

In accordance with one embodiment, there is disclosed a method of electronically documenting a visit of a patient, the method comprising: causing at least one computer to receive at least one assessment code input signal representing user identification of an assessment code representing a diagnosis of the patient; causing the at least one computer, in response to the at least one assessment code input signal, to retrieve, from at least one computer-readable medium, a first plurality of previously entered patient chart entries stored on the at least one computer-readable medium in association with the assessment code; causing the at least one computer to display at least some of the first plurality of previously entered patient chart entries for user selection; causing the at least one computer to receive at least one selection input signal representing user selection of at least one selected patient chart entry of the first plurality of previously entered patient chart entries; and causing the at least one computer, in response to the at least one selection input signal, to store the at least one selected patient chart entry on the at least one computer-readable medium in association with the visit.

In some embodiments, the first plurality of previously entered patient chart entries are stored on the at least one computer-readable medium in association with respective user identifiers. In some embodiments, causing the at least one computer to retrieve the first plurality of previously entered patient chart entries comprises causing the at least one computer to retrieve the first plurality of previously entered patient chart entries stored on the at least one computer-readable medium in association with the assessment code and in association with a user identifier of a current user.

In some embodiments, the method further comprises causing the at least one computer to receive at least one manual entry input signal representing user input of at least one manually entered patient chart entry.

In some embodiments, the at least one manual entry input signal represents user modification of at least one of the first plurality of previously entered patient chart entries.

In some embodiments, the method further comprises causing the at least one computer, in response to the at least one manual entry input signal, to store the at least one manually entered patient chart entry on the at least one computer-readable medium in association with the visit.

In some embodiments, the method further comprises causing the at least one computer to store, on the at least one computer-readable medium in association with the assessment code, any of the at least one manually entered patient chart entry that differs from each of the first plurality of previously entered patient chart entries.

In some embodiments, the method further comprises, after causing the at least one computer to store the any of the at least one manually entered patient chart entry, causing the at least one computer to retrieve, from the at least one computer-readable medium, a second plurality of previously entered patient chart entries stored on the at least one computer-readable medium in association with the assessment code, wherein the second plurality of previously entered patient chart entries comprises the any of the at least one manually entered patient chart entry.

In some embodiments, the first plurality of previously entered patient chart entries comprises: a plurality of previously entered subjective information patient chart entries; a plurality of previously entered objective data patient chart entries; a plurality of previously entered treatment plan patient chart entries; or a plurality of previously entered billing patient chart entries.

In some embodiments, the plurality of previously entered treatment plan patient chart entries comprises: a plurality of pharmaceutical prescription chart entries, each identifying, at least, a pharmaceutical dose or a treatment duration period; a plurality of referral treatment plan patient chart entries, each identifying, at least, a referral to a specialist, a referral to a clinic, or a referral to a hospital; or a plurality of investigation treatment plan patient chart entries, each identifying, at least, a laboratory test or a diagnostic test.

In some embodiments, the plurality of previously entered billing patient chart entries each identifies, at least, a service code.

In some embodiments, the method further comprises causing the at least one computer to display medical history information of the patient, the medical history information of the patient comprising medical history information representing at least one previously entered patient chart entry stored on the at least one computer-readable medium in association with the patient and in association with at least one medical history assessment code.

In some embodiments, the at least one medical history assessment code represents a recurring medical condition or a vaccination.

In accordance with one embodiment, there is disclosed an apparatus for electronically documenting a visit of a patient, the apparatus comprising: a means for receiving at least one assessment code input signal representing user identification of an assessment code representing a diagnosis of the patient; a means for retrieving, in response to the at least one assessment code input signal and from at least one computer-readable medium, a plurality of previously entered patient chart entries stored on the at least one computer-readable medium in association with the assessment code; a means for displaying at least some of the first plurality of previously entered patient chart entries for user selection; a means for receiving at least one selection input signal representing user selection of at least one selected patient chart entry of the first plurality of previously entered patient chart entries; and a means for storing, in response to the at least one selection input signal, the at least one selected patient chart entry on the at least one computer-readable medium in association with the visit.

In accordance with one embodiment, there is disclosed an apparatus for electronically documenting a visit of a patient, the apparatus comprising a processor circuit configured to: receive at least one assessment code input signal representing user identification of an assessment code representing a diagnosis of the patient; in response to the at least one assessment code input signal, retrieve, from at least one computer-readable medium, a first plurality of previously entered patient chart entries stored on the at least one computer-readable medium in association with the assessment code; cause at least one display to display at least some of the first plurality of previously entered patient chart entries for user selection; receive at least one selection input signal representing user selection of at least one selected patient chart entry of the first plurality of previously entered patient chart entries; and in response to the at least one selection input signal, store the at least one selected patient chart entry on the at least one computer-readable medium in association with the visit.

In some embodiments, the apparatus further comprises the at least one computer-readable medium.

In some embodiments, the first plurality of previously entered patient chart entries comprises a plurality of character sequences stored on the at least one computer-readable medium in association with the assessment code.

In some embodiments, the first plurality of previously entered patient chart entries are stored on the at least one computer-readable medium independently of any patient identifier.

In some embodiments, the first plurality of previously entered patient chart entries are stored on the at least one computer-readable medium in association with respective user identifiers, and wherein the processor circuit is configured to, in response to the at least one assessment code input signal, retrieve the first plurality of previously entered patient chart entries in association with the assessment code and in association with a user identifier of a current user.

In some embodiments, the assessment code comprises a numerical code.

In some embodiments, the processor circuit is further configured to receive at least one manual entry input signal representing user input of at least one manually entered patient chart entry.

In some embodiments, the at least one manual entry input signal represents user modification of at least one of the first plurality of previously entered patient chart entries.

In some embodiments, the processor circuit is further configured to, in response to the at least one manual entry input signal, store the at least one manually entered patient chart entry on the at least one computer-readable medium in association with the visit.

In some embodiments, the processor circuit is further configured to store, on the at least one computer-readable medium in association with the assessment code, any of the at least one manually entered patient chart entry that differs from each of the first plurality of previously entered patient chart entries.

In some embodiments, the processor circuit is further configured to, after causing the at least one computer to store the any of the at least one manually entered patient chart entry, retrieve, from the at least one computer-readable medium, a second plurality of previously entered patient chart entries stored on the at least one computer-readable medium in association with the assessment code, wherein the second plurality of previously entered patient chart entries comprises the any of the at least one manually entered patient chart entry.

In some embodiments, the first plurality of previously entered patient chart entries comprises: a plurality of previously entered subjective information patient chart entries; a plurality of previously entered objective data patient chart entries; a plurality of previously entered treatment plan patient chart entries; or a plurality of previously entered billing patient chart entries.

In some embodiments, the plurality of previously entered treatment plan patient chart entries comprises: a plurality of pharmaceutical prescription chart entries, each identifying, at least, a pharmaceutical dose or a treatment duration period; a plurality of referral treatment plan patient chart entries, each identifying, at least, a referral to a specialist, a referral to a clinic, or a referral to a hospital; or a plurality of investigation treatment plan patient chart entries, each identifying, at least, a laboratory test or a diagnostic test.

In some embodiments, the plurality of previously entered billing patient chart entries each identifies, at least, a service code.

In some embodiments, the first plurality of previously entered patient chart entries comprises patient chart entries from a plurality of unrelated patients.

In some embodiments, the processor circuit is further configured to cause the at least one display to display medical history information of the patient, the medical history information of the patient comprising medical history information representing at least one previously entered patient chart entry stored on the at least one computer-readable medium in association with the patient and in association with at least one medical history assessment code.

In some embodiments, the at least one medical history assessment code represents a recurring medical condition or a vaccination.

### BRIEF DESCRIPTION OF THE DRAWINGS

FIG. 1 is a perspective view of a system for documenting visits of patients in accordance with one embodiment.

FIG. 2 illustrates a computer of the system of FIG. 1.

FIG. 3 is an entity-relationship diagram of a database of the computer of FIG. 2.

FIG. 4 illustrates a user table entry of the database of FIG. 3.

FIG. 5 illustrates a clinic table entry of the database of FIG. 3.

FIG. 6 illustrates a patient table entry of the database of FIG. 3.

FIG. 7 illustrates an assessment code table entry of the database of FIG. 3.

FIG. 8 illustrates a subjective information table entry of the database of FIG. 3.

FIG. 9 illustrates an objective data table entry of the database of FIG. 3.

FIG. 10 illustrates a treatment plan table entry of the database of FIG. 3.

FIG. 11 illustrates a service code table entry of the database of FIG. 3.

FIG. 12 illustrates a billing table entry of the database of FIG. 3.

FIG. 13 illustrates a visit record table entry of the database of FIG. 3.

FIG. 14 illustrates a login page defined by user interface codes of the computer of FIG. 2.

FIG. 15 illustrates a charting interface display screen defined by the user interface codes of the computer of FIG. 2.

FIG. 16 illustrates the charting interface display screen of FIG. 15 with a charting area.

FIG. 17 illustrates the charting interface display screen of FIG. 15 with an assessment code entered in the charting area.

FIG. 18 illustrates description program codes in a program memory of the computer of FIG. 2.

FIG. 19 illustrates a subjective description page defined by the user interface codes of the computer of FIG. 2.

FIG. 20 illustrates an objective description page defined by the user interface codes of the computer of FIG. 2.

FIG. 21 illustrates a master medicine list page defined by the user interface codes of the computer of FIG. 2.

FIG. 22 illustrates the charting interface display screen of FIG. 15 with additional patient chart entries entered in the charting area.

FIG. 23 illustrates a prescription script interface defined by the user interface codes of the computer of FIG. 2.

FIG. 24 illustrates service list program codes in the program memory of the computer of FIG. 2.

FIG. 25 illustrates a service code list page defined by the user interface codes of the computer of FIG. 2.

FIG. 26 illustrates end visit program codes in the program memory of the computer of FIG. 2.

FIG. 27 illustrates a medical history region defined by the user interface codes of the computer of FIG. 2.

FIG. 28 illustrates a vaccination list defined by the user interface codes of the computer of FIG. 2.

### DETAILED DESCRIPTION

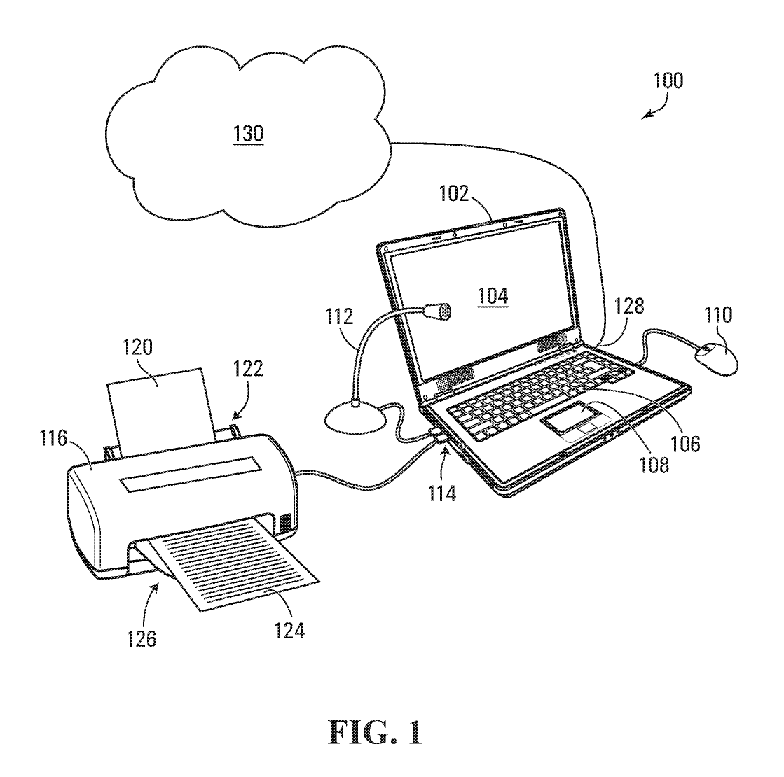

Referring to FIG. 1, an illustrative system for electronically documenting visits of patients in electronic patient chart entries in accordance with one embodiment is shown generally at 100. The system 100 includes a computer 102 for use by a healthcare professional user. The computer 102 is a laptop personal computer having a display screen 104 and input devices including a keyboard 106, a trackpad 108, a mouse 110, and a microphone 112. The computer 102 includes a printer interface 114 for communicating with a printer 116. The computer 102 also includes a network interface 128 for communicating over a network 130, such as the Internet for example. In general, the computer 102 includes various hardware and software components that enable the computer 102 to perform various functions of a personal computer, including executing program codes such as the program codes described below. Although the computer 102 in the embodiment shown is a laptop personal computer, alternative embodiments may include desktop personal computers, tablets, or other apparatuses that enable the user of such an apparatus to perform similar functions. Also, although the computer 102 in the embodiment shown is a single computer, alternative embodiments may include more than one computer or distributed computer components to perform similar functions.

The printer 116 is a personal printer capable of taking blank sheets of paper 120 at an input 122, printing information 124 (such as text and/or images, for example) on the sheets of paper 120, and outputting printed sheets of paper at an output 126. The printer 116 includes various hardware and firmware components that enable the printer 116 to perform various functions of a personal printer, such as a laser assembly and ink toner. Although the printer 116 in the embodiment shown is a personal printer, alternative embodiments may include a networked or shared printer, or other apparatuses that enable the user of such an apparatus to perform similar functions.

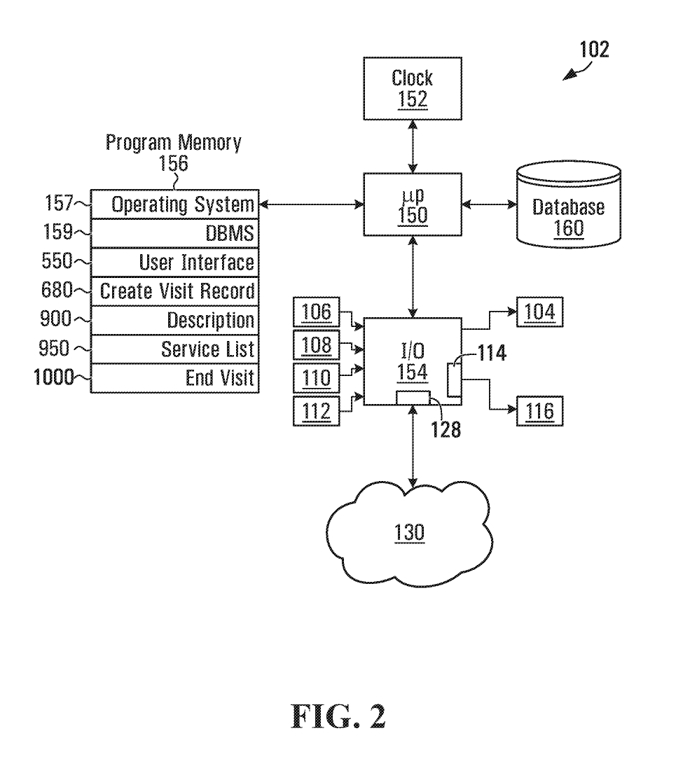

Referring to FIG. 2, the computer 102 includes a processor circuit, which in the embodiment shown includes a microprocessor 150, and a clock 152, an input/output (“I/O”) interface 154, a program memory 156, and a database 160 all in communication with the microprocessor 150. The clock 152 maintains values representing a current date and time, and provides such values to the microprocessor 150 as discussed below. The I/O interface 154 includes input signal interfaces that facilitate receipt of input signals from the input devices (including the keyboard 106, the trackpad 108, the mouse 110, and the microphone 112 shown in FIG. 1 in the embodiment shown, although in some embodiments the display screen 104 may be a touch screen, and in such embodiments the display screen 104 may also be an input device), output signal interfaces that facilitate generation of output signals to control the display screen 104 and the printer 116 using the printer interface 114, and the network interface 128 to facilitate communication using the network 130. The program memory 156 and the database 160 may be implemented on the same or different ones of, or on a combination of more than one of, a random access memory (“RAM”), a hard disk drive (“HDD”), and other computer-readable and/or -writable memory. In alternative embodiments, the computer 102 may be partly or fully implemented using different hardware logic, which may include discrete logic circuits and/or an application specific integrated circuit (“ASIC”), for example.

The program memory 156 stores executable program codes for directing the microprocessor 150 to execute various functions of the computer 102. The program memory 156 stores various blocks of codes, including operating system codes 157 of an operating system for the computer 102. In the embodiment shown, the operating system codes 157 implement a Microsoft Windows™ operating system. The program memory 156 also includes database management system (“DBMS”) codes 159 for managing the database 160 as described below.

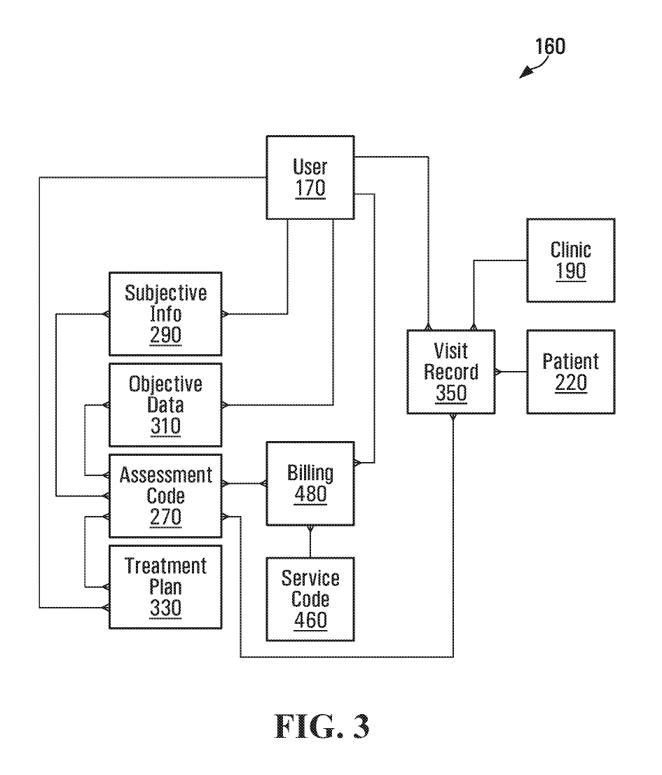

The database 160 is a relational database including a plurality of tables shown generally in FIG. 3. The various tables of the database 160 can each store any number of instances of a table entry as described below. The various instances of the table entry each include various fields, and an instance of such a table entry can store particular values in such fields. However, alternative embodiments may include different databases, or may store data in one or more storage media that may or may not store the data in databases.

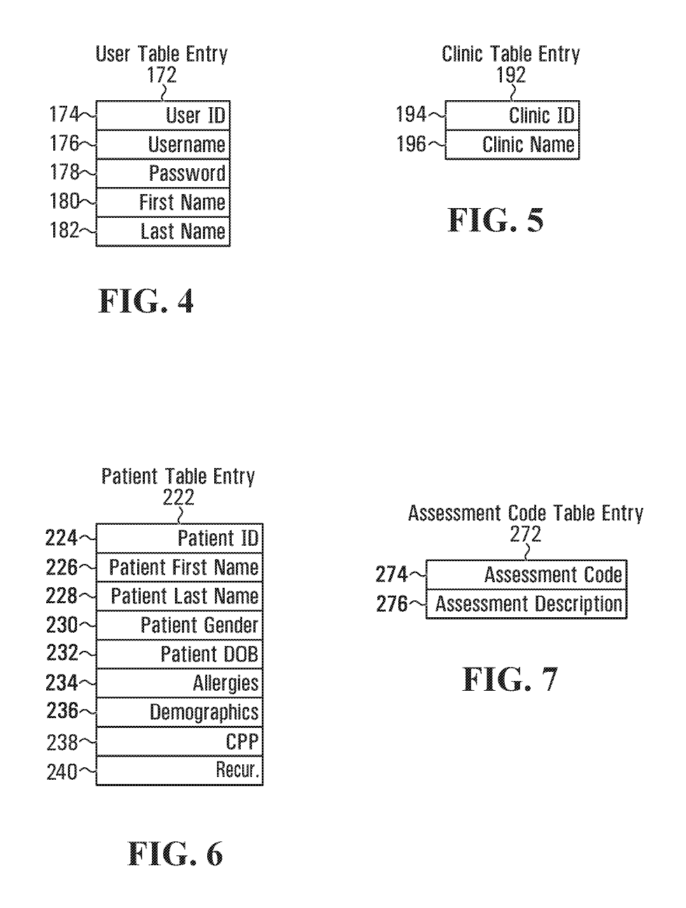

The database 160 includes a user table 170 (shown in FIG. 3) that can store any number of instances of a user table entry shown generally at 172 in FIG. 4. In general, each instance of the user table entry 172 is associated with a user of the computer 102 (shown in FIGS. 1 and 2), which in the embodiment shown may include a healthcare professional user such as a doctor, a nurse, or an office manager of a clinic, for example.

Referring to FIG. 4, the user table entry 172 includes a user identifier field 174, which stores an integer assigned by the DBMS codes 159 (shown in FIG. 2) to identify an instance of the user table entry 172 uniquely in the user table 170 (shown in FIG. 3). The user table entry 172 also includes a username field 176 and a password field 178, and a user associated with an instance of the user table entry 172 can sign on into a session on the computer 102 using the username and password content stored in the username field 176 and the password field 178 respectively. The password field 178 may store an encrypted password for greater security in some embodiments. The user table entry 172 also includes a first name field 180 and a last name field 182, which store representations of a first name and a last name respectively of a user associated with an instance of the user table entry 172.

Referring back to FIG. 3, the database 160 also includes a clinic table 190 that can store any number of instances of a clinic table entry shown generally at 192 in FIG. 5. In general, each instance of the clinic table entry 192 is associated with a clinic at which a user of the computer 102 can document a visit of a patient. Referring to FIG. 5, the clinic table entry 192 includes a clinic identifier field 194, which stores an integer assigned by the DBMS codes 159 (shown in FIG. 2) to identify an instance of the clinic table entry 192 uniquely in the clinic table 190 (shown in FIG. 3). The clinic table entry 192 also includes a clinic name field 196 for storing a name of a clinic associated with an instance of the clinic table entry 192.

Referring back to FIG. 3, the database 160 also includes a patient table 220 that can store any number of instances of a patient table entry shown generally at 222 in FIG. 6. In general, each instance of the patient table entry 222 is associated with a patient of one or more users of the computer 102. Referring to FIG. 6, the patient table entry 222 includes a patient identifier field 224, which stores an integer assigned by the DBMS codes 159 (shown in FIG. 2) to identify an instance of the patient table entry 222 uniquely in the patient table 220 (shown in FIG. 3). The patient table entry 222 also includes a patient first name field 226 and a patient last name field 228, which store representations of a first name and a last name respectively of a patient associated with an instance of the patient table entry 222. The patient table entry 222 also includes a patient gender field 230 and a patient date of birth field 232 respectively for storing representations of the gender and the year, month, and day of birth of a patient associated with an instance of the patient table entry 222. The patient table entry 222 also includes an allergies field 234 for storing representations of patient allergies (to drugs, for example) and a demographics field 236 for storing other demographic information such as weight, height, alcohol drinking history, smoking history, habits, occupation, marital status, family history, and medication history, for example. The patient table entry 222 also includes a cumulative patient profile (“CPP”) field 238 for storing CPP information as described below, for example, and a chronic or recurring diseases field 240 for identifying chronic or recurring diseases of a patient, for example.

Referring back to FIG. 3, the database 160 also includes an assessment code table 270 that can store any number of instances of an assessment code table entry shown generally at 272 in FIG. 7. In general, each instance of the assessment code table entry 272 is associated with an assessment code representing a diagnosis in a system of diagnostic codes, such as the International Classification of Diseases (“ICD”) maintained by the World Health Organization, for example.

Referring to FIG. 7, the assessment code table entry 272 includes an assessment code field 274, which stores a numerical code that both uniquely identifies an instance of the assessment code table entry 272 in the assessment code table 270 (shown in FIG. 3) and represents an ICD-9 numerical assessment code associated with the instance of the assessment code table entry 272. The assessment code table entry 272 also includes an assessment description field 276 for storing a representation of a disease description associated with an instance of the assessment code table entry 272. For example, in one instance of the assessment code table entry 272, the assessment code field 274 may store the ICD-9 code “174”, and the assessment description field 276 may store a description “malignant neoplasm of female breast”, which is a description of the disease identified by the ICD-9 code “174”. In another instance of the assessment code table entry 272, the assessment code field 274 may store the code ICD-9 “401”, and the assessment description field 276 may store a description “Essential Hypertension, HTN”, which is a description of the disease identified by the ICD-9 code “401”. Although the assessment code table entry 272 in the embodiment shown stores an ICD-9 code, alternative embodiments may store assessment codes of one or more of various different systems of diagnostic codes, such as ICD-10 or any other system of diagnostic codes, for example.

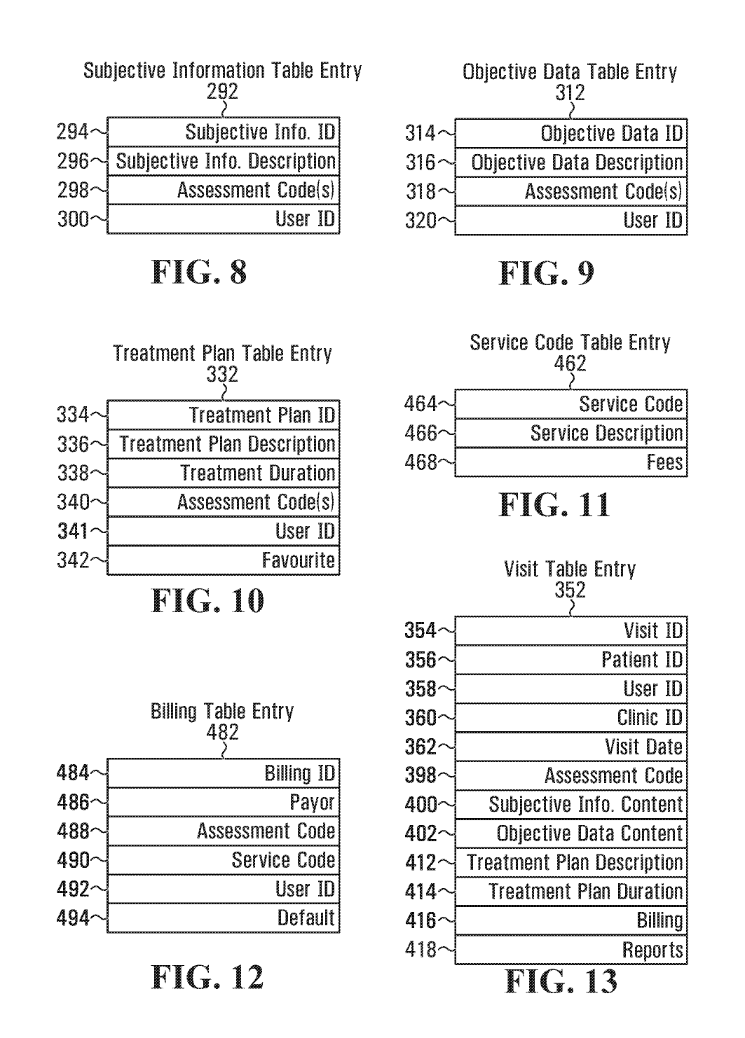

Referring back to FIG. 3, the database 160 also includes a subjective information table 290 that can store any number of instances of a subjective information table entry shown generally at 292 in FIG. 8. Generally, each instance of the subjective information table entry 292 represents a previously entered subjective information patient chart entry, such as a subjective component of an electronic SOAP note previously entered and stored in the database 160, for example by a user of the computer 102 (shown in FIGS. 1 and 2), in association with an assessment code associated with an instance of the assessment code table entry 272 (shown in FIG. 7). In some methods of electronically documenting (or charting) visits of patients, SOAP notes include subjective (“S”), objective (“O”), assessment (“A”), and plan (“P”) components. In general, the subjective (or “S”) component of an electronic SOAP note represents a some or all of a subjective report (either directly from a patient or from a caregiver of the patient, for example) on how the patient has been feeling or currently feels, or on the patient's chief complaint or reason for visiting the user of the computer 102.

Referring to FIG. 8, the subjective information table entry 292 includes a subjective information identifier field 294, which stores an integer assigned by the DBMS codes 159 (shown in FIG. 2) to identify an instance of the subjective information table entry 292 uniquely in the subjective information table 290 (shown in FIG. 3). The subjective information table entry 292 also includes a subjective information description field 296, which stores a subjective component of an electronic SOAP note, or more generally a previously entered subjective information patient chart entry. The subjective information description field 296 may store a character sequence or other representation of the subjective component of the electronic SOAP note.

Additionally, the subjective information table entry 292 includes an assessment code field 298, which stores one or more assessment codes from the assessment code field 274 of respective instances of the assessment code table entry 272 (shown in FIG. 7). Therefore, an instance of the subjective information table entry 292 stores, in the database 160, the subjective component of the electronic SOAP note in the subjective information description field 296 in association with the one or more assessment codes in the assessment code field 298. An instance of the subjective information table entry 292 may be associated with one or more instances of the assessment code table entry 272 (shown in FIG. 7) because the assessment code field 298 can store one or more assessment codes, and an instance of the assessment code table entry 272 may be associated with one or more instances of the subjective information table entry 292 if the assessment code field 298 of the one or more instances of the subjective information table entry 292 identifies a common instance of the assessment code table entry 272.

Additionally, the subjective information table entry 292 includes a user identifier field 300, which stores a user identifier from the user identifier field 174 of an instance of the user table entry 172 (shown in FIG. 4). The user identifier field 300 identifies a user associated with an instance of the user table entry 172, so an instance of the subjective information table entry 292 stores, in the database 160, the subjective component of the electronic SOAP note in the subjective information description field 296 in association with the user associated with the instance of the user table entry 172 identified by the user identifier in the user identifier field 300. Different subjective components of electronic SOAP notes can be associated with a particular user over time, so one or more instances of the subjective information table entry 292 may be associated with one instance of the user table entry 172 if the user identifier field 300 of the one or more instances of the subjective information table entry 292 identify a common instance of the user table entry 172. In the embodiment shown, the subjective information table entry 292 does not include any patient identifier, so the subjective information table 290 stores previously entered subjective information patient chart entries in the database 160 independently of any patient identifier.

Referring back to FIG. 3, the database 160 also includes an objective data table 310 that can store any number of instances of an objective data table entry shown generally at 312 in FIG. 9. Generally, each instance of the objective data table entry 312 represents a previously entered objective data patient chart entry, such as an objective (or “O”) component of an electronic SOAP note previously entered and stored in the database 160, for example by a user of the computer 102 (shown in FIGS. 1 and 2), in association with an assessment code associated with an instance of the assessment code table entry 272 (shown in FIG. 7). In general, the objective (or “O”) component of an electronic SOAP note represents some or all information that a healthcare provider (such as the user of the computer 102, for example) observes or measures from a patient during a visit of the patient, and may include one or more of vital signs such as blood pressure, other measurements such as body weight, findings from physical examinations, or results from completed laboratory or other diagnostic tests already, for example.

Referring to FIG. 9, the objective data table entry 312 includes an objective data identifier field 314, which stores an integer assigned by the DBMS codes 159 (shown in FIG. 2) to identify an instance of the objective data table entry 312 uniquely in the objective data table 310 (shown in FIG. 3). The objective data table entry 312 also includes an objective data description field 316, which stores an objective component of an electronic SOAP note, or more generally a previously entered objective data patient chart entry. The objective data description field 316 may store a character sequence or other representation of the objective component of the electronic SOAP note.

Additionally, the objective data table entry 312 includes an assessment code field 318, which stores one or more assessment codes from the assessment code field 274 of respective instances of the assessment code table entry 272 (shown in FIG. 7). Therefore, an instance of the objective data table entry 312 stores, in the database 160, the objective component of the electronic SOAP note in the objective data description field 316 in association with the one or more assessment codes in the assessment code field 318. An instance of the objective data table entry 312 may be associated with one or more instances of the assessment code table entry 272 (shown in FIG. 7) because the assessment code field 318 can store one or more assessment codes, and an instance of the assessment code table entry 272 may be associated with one or more instances of the objective data table entry 312 if the assessment code field 318 of the one or more instances of the objective data table entry 312 identifies a common instance of the assessment code table entry 272.

Additionally, the objective data table entry 312 includes a user identifier field 320, which stores a user identifier from the user identifier field 174 of an instance of the user table entry 172 (shown in FIG. 4). The user identifier field 320 identifies a user associated with an instance of the user table entry 172, so an instance of the objective data table entry 312 stores, in the database 160, the objective component of the electronic SOAP note in the objective data description field 316 in association with the user associated with the instance of the user table entry 172 identified by the user identifier in the user identifier field 320. Different objective components of electronic SOAP notes can be associated with a particular user over time, so one or more instances of the objective data table entry 312 may be associated with one instance of the user table entry 172 if the user identifier field 320 of the one or more instances of the objective data table entry 312 identify a common instance of the user table entry 172. In the embodiment shown, the objective data table entry 312 does not include any patient identifier, so the objective data table 310 stores previously entered objective data patient chart entries in the database 160 independently of any patient identifier.

Referring back to FIG. 3, the database 160 also includes a treatment plan table 330 that can store any number of instances of a treatment plan table entry shown generally at 332 in FIG. 10. Generally, each instance of the treatment plan table entry 332 represents a previously entered treatment plan patient chart entry, such as a treatment plan (or “P”) component of an electronic SOAP note previously entered and stored in the database 160, for example by a user of the computer 102 (shown in FIGS. 1 and 2), in association with an assessment code associated with an instance of the assessment code table entry 272 (shown in FIG. 7). In general, the treatment plan (or “P”) component of an electronic SOAP note represents some or all of a healthcare provider's plan to treat a patient's concerns, and may include one or more of a drug prescription, a procedure performed or to be performed, referral to a specialist, referral to another clinic or to a hospital, further laboratory or diagnostic tests, a note or letter by the healthcare provider, patient education, or patient instruction, for example. As other examples, a requisition for a blood sugar report can be a treatment plan (or “P”) component of an electronic SOAP note stored in association with an assessment code “250” (an ICD-9 code for diabetes), a requisition for an electrocardiogram (“ECG”) report can be a treatment plan (or “P”) component of an electronic SOAP note stored in association with an ICD-9 code for chest pain, and a requisition for special or all medication for high blood pressure can be treatment plan (or “P”) components of electronic SOAP notes stored in association with the ICD-9 code “401” for and retrieved during future charting for high blood pressure.

Referring to FIG. 10, the treatment plan table entry 332 includes a treatment plan identifier field 334, which stores an integer assigned by the DBMS codes 159 (shown in FIG. 2) to identify an instance of the treatment plan table entry 332 uniquely in the treatment plan table 330 (shown in FIG. 3). The treatment plan table entry 332 also includes a treatment plan description field 336, which stores a treatment plan component of an electronic SOAP note, or more generally a previously entered treatment plan patient chart entry. The treatment plan description field 336 may store a character sequence or other representation of the treatment plan component of the electronic SOAP note.

The treatment plan table entry 332 also includes a treatment duration field 338, which may store a representation of treatment duration information, such as a number of administrations of a drug or a dosage regime for example, applicable to the treatment plan component of the electronic SOAP note stored in the treatment plan description field 336 of the same instance of the treatment plan table entry 332. Therefore, numerous instances of the treatment plan table entry 332 may include a same treatment plan component of an electronic SOAP note in their respective treatment plan description fields 336 but different treatment durations in their respective treatment duration fields 338, and also numerous instances of the treatment plan table entry 332 may include a same treatment duration in their respective treatment duration fields 338 but different treatment plan components of electronic SOAP notes in their respective treatment plan description fields 336. Also, some treatment plan components of an electronic SOAP note do not include duration information, so some instances of the treatment plan table entry 332 may not include any treatment duration information in the treatment duration field 338.

Additionally, the treatment plan table entry 332 includes an assessment code field 340, which stores one or more assessment codes from the assessment code field 274 of respective instances of the assessment code table entry 272 (shown in FIG. 7). Therefore, an instance of the treatment plan table entry 332 stores, in the database 160, the treatment plan component of the electronic SOAP note in the treatment plan description field 336, and any treatment duration information in the treatment duration field 338, in association with the one or more assessment codes in the assessment code field 340. An instance of the treatment plan table entry 332 may be associated with one or more instances of the assessment code table entry 272 (shown in FIG. 7) because the assessment code field 340 can store one or more assessment code, and an instance of the assessment code table entry 272 may be associated with one or more instances of the treatment plan table entry 332 if the assessment code field 340 of the one or more instances of the treatment plan table entry 332 identifies a common instance of the assessment code table entry 272.

Additionally, the treatment plan table entry 332 includes a user identifier field 341, which stores a user identifier from the user identifier field 174 of an instance of the user table entry 172 (shown in FIG. 4). The user identifier field 341 identifies a user associated with an instance of the user table entry 172, so an instance of the treatment plan table entry 332 stores, in the database 160, the treatment plan component of the electronic SOAP note in the treatment plan description field 336 in association with the user associated with the instance of the user table entry 172 identified by the user identifier in the user identifier field 341. Different treatment plan components of electronic SOAP notes can be associated with a particular user over time, so one or more instances of the treatment plan table entry 332 may be associated with one instance of the user table entry 172 if the user identifier field 341 of the one or more instances of the treatment plan table entry 332 identify a common instance of the user table entry 172.

The treatment plan table entry 332 also includes a favorite field 342, which stores a Boolean value representing whether the treatment plan component of the electronic SOAP note stored in the treatment plan description field 336 of an instance of the treatment plan table entry 332 is a favorite of the user identified by the user identifier field 341. For example, if the favorite field of an instance of the treatment plan table entry 332 stores “TRUE”, then the user identified by the user identifier field 341 may more easily identify the treatment plan component of the electronic SOAP note stored in the treatment plan description field 336 of that instance of the treatment plan table entry 332. In the embodiment shown, the treatment plan table entry 332 does not include any patient identifier, so the treatment plan table 330 stores previously entered treatment plan patient chart entries in the database 160 independently of any patient identifier.

In other embodiments, treatment plan patient chart entries may be classified into different types. Such different types may be stored in separate tables in the database 160, or the treatment plan table entry 332 may include a field indicating a type of treatment plan patient chart entry. For example, in one embodiment, treatment plan patient chart entries may be classified into three categories, namely as a prescription (indicated by “P”) for drugs or medications, as advice (indicated by “Pa” instead of simply “P”) such as advice to lose weight, to rest, to drink fluids, to return for a blood test in the future, or to see a specialist, for example, and as a note (indicated by “Pn” instead of simply “P”) for other treatment plan patient chart entries such as a conclusion that the patient requires rest from work, that the patient is fit to work, or that the patient is unfit for air travel, for example. For simplicity, the embodiment described herein refers to treatment plan patient chart entries indicated by “P”, but alternative embodiments may include further classification of treatment plan patient chart entries such classification into categories indicated as “P”, as “Pa”, and as “Pn” as described above, for example.

Referring back to FIG. 3, the database 160 also includes a service code table 460 that can store any number of instances of a service code table entry shown generally at 462 in FIG. 11. In general, each instance of the service code table entry 462 is associated with a type of service that a user of the computer 102 (shown in FIGS. 1 and 2) may provide to a patient.

Referring to FIG. 11, the service code table entry 462 includes a service code field 464, which stores a numerical code that both uniquely identifies an instance of the service code table entry 462 in the service code table 460 and represents a type of service that a user of the computer 102 may provide to a patient. The service code table entry 462 also includes a service description field 466, which stores a representation of a description of a type of service associated with an instance of the service code table entry 462, and a fees field 468, which stores a representation of a fee to be charged to a payor (such as the patient, a government-administered health insurance plan, or an insurance company, for example) for the service associated with the instance of the service code table entry 462.

For example, in an instance of the service code table entry 462, the service code field 464 may store the code “00100”, the service description field 466 may store the description “Visit—in office (2-49)”, and the fees field 468 may store the fee “$30.15”, and such an instance of the service code table entry 462 associates the code “00100” with an in-office visit for patients aged 2 to 49 and with a fee of “$30.15”. In another instance of the service code table entry 462, for example, the service code field 464 may store the code “00120”, the service description field 466 may store the description may store the description “Counseling—in office (2-49)”, and the fees field 468 may store the fee “$52.45”, and such an instance of the service code table entry 462 associates the code “00120” with an in-office individual counseling for patients aged 2 to 49 and with a fee of “$52.45”.

The service code table 460 may be configured to include information regarding service codes that a user of the a user of the computer 102 may provide.

Referring back to FIG. 3, the database 160 also includes a billing table 480 that can store any number of instances of a billing table entry shown generally at 482 in FIG. 12. Generally, each instance of the billing table entry 482 represents a previously entered billing patient chart entry, such as a service code or a payor (or both) previously stored in the database 160, for example by a user of the computer 102 (shown in FIGS. 1 and 2), in association with an assessment code associated with an instance of the assessment code table entry 272 (shown in FIG. 7).

Referring to FIG. 12, the billing table entry 482 includes a billing identifier field 484, which stores an integer assigned by the DBMS codes 159 (shown in FIG. 2) to identify an instance of the billing table entry 482 uniquely in the billing table 480. The billing table entry 482 also includes a payor identification field 486, which stores the identity of a payor such as “Insurer” or “Patient”. The “Insurer” may be a government-administered health insurance plan such as the Medical Services Plan of British Columbia or a private health insurer, for example. The billing table entry 482 also includes an assessment code field 488, which stores one or more assessment codes from the assessment code field 274 of respective instances of the assessment code table entry 272 (shown in FIG. 7). The billing table entry 482 also includes a service code field 490, which stores a service code from the service code field 464 of an instance of the service code table entry 462 (shown in FIG. 11), which is a previously entered billing patient chart entry or more generally a previously entered patient chart entry. Therefore, an instance of the billing table entry 482 stores, in the database 160, the service code in the service code field 490 in association with the payor in the payor identification field 486 and in association with the one or more assessment codes in the assessment code field 488.

In some embodiments, the assessment code field 488 stores only one assessment code, in which case each instance of the billing table entry 482 may be associated with only one instance of the assessment code table entry 272 and only one instance of the service code table entry 462. For example, one instance of the billing table entry 482 may store in the assessment code field 488 the assessment code “487” (an ICD-9 code identifying influenza) and in the service code field 490 the service code “00100” (a service code representing an in-office visit for patients aged 2 to 49), thereby associating the assessment code “487” with the service code “00100”.

In other embodiments, the assessment code field 488 may store more than one assessment code. In such embodiments, each instance of the billing table entry 482 may be associated with more than one instance of the assessment code table entry 272. For example, one instance of a billing table entry 482 may store in the assessment code field 488 the assessment codes “487 311 595” (ICD-9 codes identifying, respectively, influenza, depression, and urinary tract infection) and may store in the service code field 490 the service code “00100”, thereby associating the assessment codes “487”, “311”, and “595” with the service code “00100”.

Accordingly, an instance of the billing table entry 482 may be associated with one or more instances of the assessment code table entry 272 (shown in FIG. 7) because the assessment code field 488 can store one or more assessment codes. Additionally, an instance of the assessment code table entry 272 may be associated with one or more instances of the billing table entry 482 if the assessment code field 488 of the one or more instances of the billing table entry 482 identifies a common instance of the assessment code table entry 272. Further, an instance of the service code table entry 462 may be associated with more than one instance of the billing table entry 482 if the service code field 490 of the more than one instance of the billing table entry 482 identifies a common instance of the service code table entry 462.

The billing table entry 482 also includes a user identifier field 492, which stores a user identifier from the user identifier field 174 of an instance of the user table entry 172 (shown in FIG. 4), so an instance of billing table entry 482 stores, in the database 160, a service code (identified by the service code field 490) and a payor (identified by the payor identification field 486) in association with the user identified by the user identifier field 492. Different combinations of service codes and payors can be associated with a particular user over time, so one or more instances of the billing table entry 482 may be associated with one instance of the user table entry 172 if the user identifier field 492 of the one or more instances of the billing table entry 482 identify a common instance of the user table entry 172. In the embodiment shown, the billing table entry 482 does not include any patient identifier, so the billing table 480 stores previously entered billing patient chart entries in the database 160 independently of any patient identifier.

The billing table entry 482 also includes a default field 494, which stores a Boolean value representing whether the service code stored in the service code field 490 (identifying an instance of the service code table entry 462) is a default service code for the one or more assessment codes stored in the assessment code field 488 and for the user identified by the user identifier field 492.

Referring back to FIG. 3, the database 160 also includes a visit record table 350 that can store any number of instances of a visit record table entry shown generally at 352 in FIG. 13. Referring to FIG. 13, the visit record table entry 352 includes a visit identifier field 354, which stores an integer assigned by the DBMS codes 159 (shown in FIG. 2) to identify an instance of the visit record table entry 352 uniquely in the visit record table 350. The visit record table entry 352 also includes: a patient identifier field 356, which stores a patient identifier from the patient identifier field 224 of an instance of the patient table entry 222 (shown in FIG. 6); a user identifier field 358, which stores a user identifier from the user identifier field 174 of an instance of the user table entry 172 (shown in FIG. 4); and a clinic identifier field 360, which stores a clinic identifier from the clinic identifier field 194 of an instance of the clinic table entry 192 (shown in FIG. 5). Generally, each instance of the visit record table entry 352 is associated with a visit of a patient (identified by the patient identifier field 356) to a doctor, other medical professional, or other user (identified by the user identifier field 358) at a clinic (identified by the clinic identifier field 360). The visit record table entry 352 also includes a visit date field 362, which stores representations of date of a visit associated with an instance of the visit record table entry 352.

The visit record table entry 352 also includes an assessment code field 398, which stores at least one assessment code from the assessment code field 274 of an instance of the assessment code table entry 272 (shown in FIG. 7). In some embodiments, the assessment code field 398 stores only one assessment code, in which case each instance of the visit record table entry 352 may be associated with only one instance of the assessment code table entry 272. In other embodiments, the assessment code field 398 may store one or more assessment codes, in which case each instance of the visit record table entry 352 may be associated with one or more instances of the assessment code table entry 272. An instance of the assessment code table entry 272 may be associated with one or more instances of the visit record table entry 352 if the assessment code field 398 of the one or more instances of the visit record table entry 352 identifies a common instance of the assessment code table entry 272.

The visit record table entry 352 also includes a subjective information description field 400, which may store one or more subjective information patient chart entries, such as subjective (or “S”) components of an electronic SOAP note for example, and an objective data description field 402, which may store one or more objective data patient chart entries, such as objective (or “O”) components of an electronic SOAP note for example. The visit record table entry 352 also includes a treatment plan description field 412, which may store one or more treatment plan patient chart entries, such treatment plan (or “P”) components of an electronic SOAP note for example, and a treatment duration field 414, which may store treatment duration information associated with each of the one or more treatment plan patient chart entries stored in the treatment plan description field 412. In some embodiments, one or both of the subjective information description field 400 and the objective data description field 402 may store one or more patient-specific audio recordings, one or more patient-specific video recordings, or both. In such embodiments, the computer 102 may further include a video camera (not shown) in communication with the I/O interface 154.

The visit table entry 352 also includes a billing field 416, which may store billing information associated with the visit of a patient associated with that instance of the visit record table entry 352. The billing field 416 may store billing information such as services provided, fees, and a payor for the fees.

The visit table entry 352 also includes a reports field 418. After a patient visit, a user of the user of the computer 102 (shown in FIGS. 1 and 2) may receive one or more reports or other correspondence from a laboratory, specialist, other clinic, or hospital, for example, and the reports field 418 of an instance of the visit table entry 352 may store such reports or other correspondence in the database 160 in association with in association with the assessment code of the patient visit stored in the assessment code field 398 of the instance of the visit table entry 352.

An instance of the patient table entry 222 (shown in FIG. 6) may be associated with one or more instances of the visit record table entry 352 if the patient identifier fields 356 of the one or more instances of the visit record table entry 352 store a common patient identifier identifying the instance of the patient table entry 222. Similarly, an instance of the user table entry 172 (shown in FIG. 4) may be associated with one or more instances of the visit record table entry 352 if the user identifier fields 358 of the one or more instances of the visit record table entry 352 store a common user identifier identifying the instance of the user table entry 172. Also, an instance of the clinic table entry 192 (shown in FIG. 5) may be associated with one or more instances of the visit record table entry 352 if the clinic identifier fields 360 of the one or more instances of the visit record table entry 352 store a common clinic identifier identifying the instance of the clinic table entry 192.

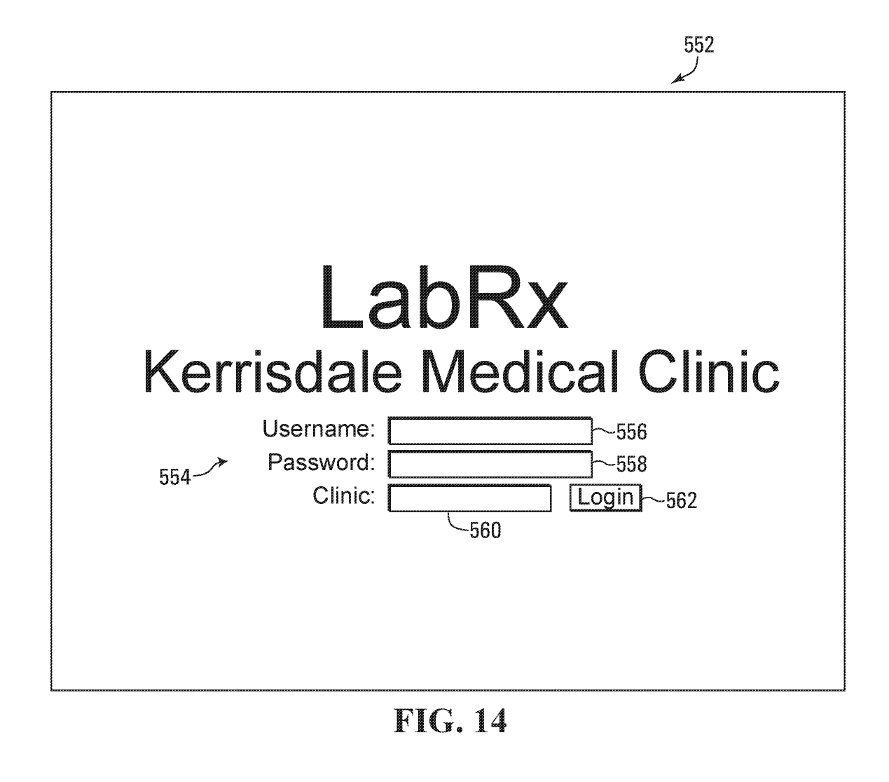

Referring back to FIG. 2, the operating system codes 157 allow a user of the computer 102 to cause the computer 102 to execute various program codes from the program memory 156, such as program codes from a charting application including user interface codes 550 for establishing and controlling various user interfaces of the computer 102 that enable a user of the computer 102 to interact with the computer 102 in the charting application as described below. Initially, when the user of the computer 102 causes the computer 102 to execute the user interface codes 550, the user interface codes 550 direct the microprocessor 150 to cause the display screen 104 to display a login page of the charting application shown generally at 552 in FIG. 14.

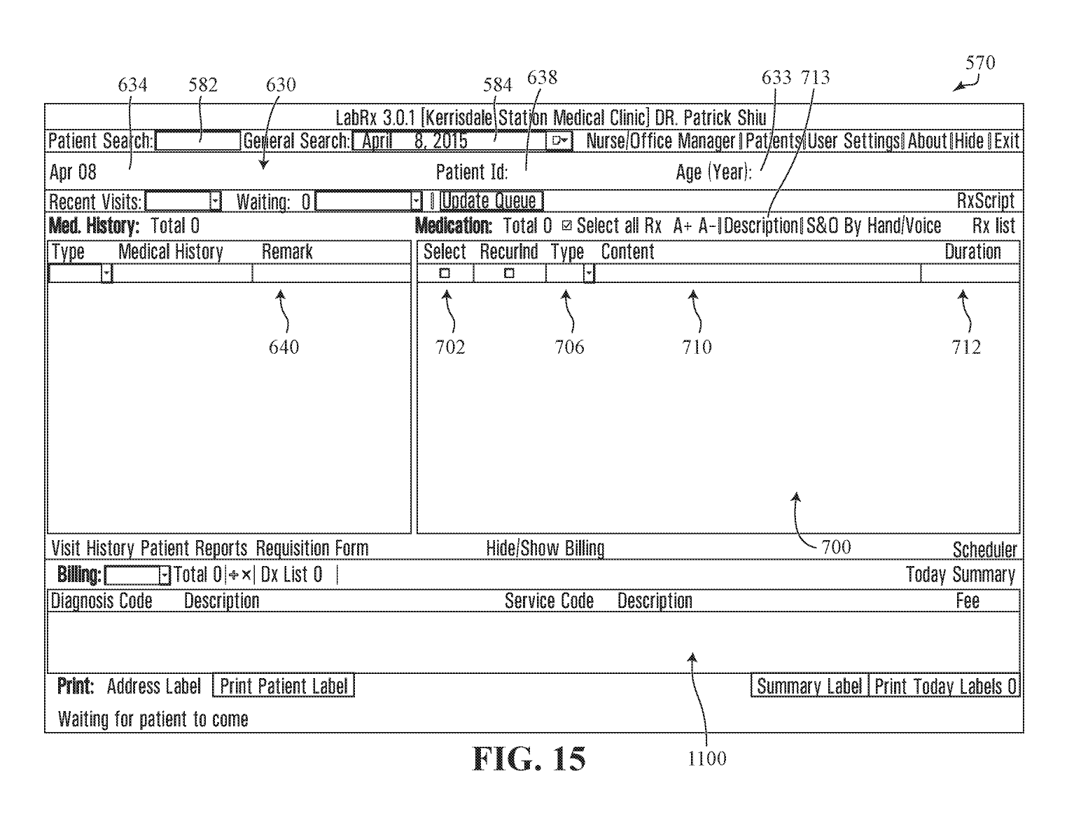

Referring to FIG. 14, the login page 552 includes a sign-in region shown generally at 554, which includes a username input field 556, a password input field 558, a clinic selection field 560, and a login button 562. The input fields 556 and 558 receive text input by a user of the computer 102 (shown in FIGS. 1 and 2), and the clinic selection field 560 allows a user to select an input representing a clinic. In the embodiment shown in FIGS. 14 and 15, a user selects a clinic identified as “Kerrisdale Station Medical Clinic”. When the user selects the login button 562, the user interface codes 550 directs the DBMS codes 159 (shown in FIG. 2) to search for an instance of the user table entry 172 (shown in FIG. 4) with a username stored in the username field 176 matching the text inputted into the user name input field 556, and if, in such an instance of the user table entry 172, a password stored in the password field 178 matches the text inputted into the password input field 558, then the user interface codes 550 initiate a session for the user in the charting application by establishing and controlling a charting interface, which includes causing the display screen 104 (shown in FIG. 2) to display a charting interface page shown generally at 570 in FIG. 15.

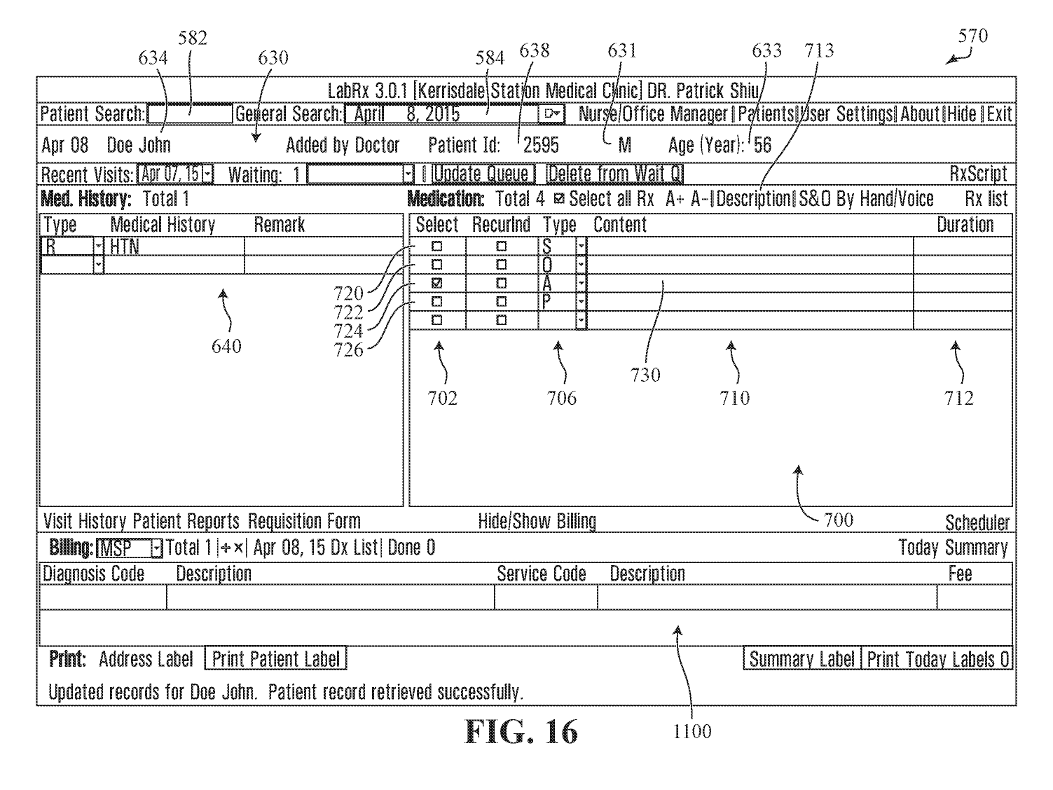

Referring to FIG. 15, the charting interface page 570 initially allows the user to select a patient for a visit to be documented. For example, the user may select a patient by entering patient-identifying information in a patient search input field 582, which allows the user of the computer 102 (shown in FIGS. 1 and 2) to query the patient table 220 (shown in FIG. 3) for an instance of the patient table entry 222 (shown in FIG. 6) associated with text inputted into the patient search input field 582. In the embodiment shown in FIG. 16, a patient “John Doe” is selected and entered into a wait queue. The user may also select a visit date using a visit date selection field 584, which allows the user of the computer 102 to select an applicable visit date, which may be a current date retrieved from the clock 152 (shown in FIG. 2) or a different manually entered date to document a visit of a patient on an earlier date, for example.

Referring to FIG. 16, the charting interface page 570 includes a patient information region 630 including a patient name field 634, a patient identifier field 638, a gender field 631, and an age field 633. As illustrated in FIG. 16, after a patient is selected using the patient search input field 582 as described above, the user interface codes 550 (shown in FIG. 2) direct the microprocessor 150 (shown in FIG. 2) to display in the patient information region 630 content from an instance of the patient table entry 222 (shown in FIG. 6) that is associated with the selected patient. In the embodiment shown, the user interface codes 550 retrieve the instance of the patient table entry 222 that is associated with the selected patient and display in the patient name field 634 a name of the patient retrieved from the patient first name field 226 and the patient last name field 228 of the instance of the patient table entry 222, in the patient identifier field 638 a patient identifier retrieved from the patient identifier field 224 of the instance of the patient table entry 222, in the gender field 631 a gender retrieved from the patient gender field 230 of the instance of the patient table entry 222, and in the age field 633 an age (in years) calculated from the patient date of birth field 232 of the instance of the patient table entry 222.

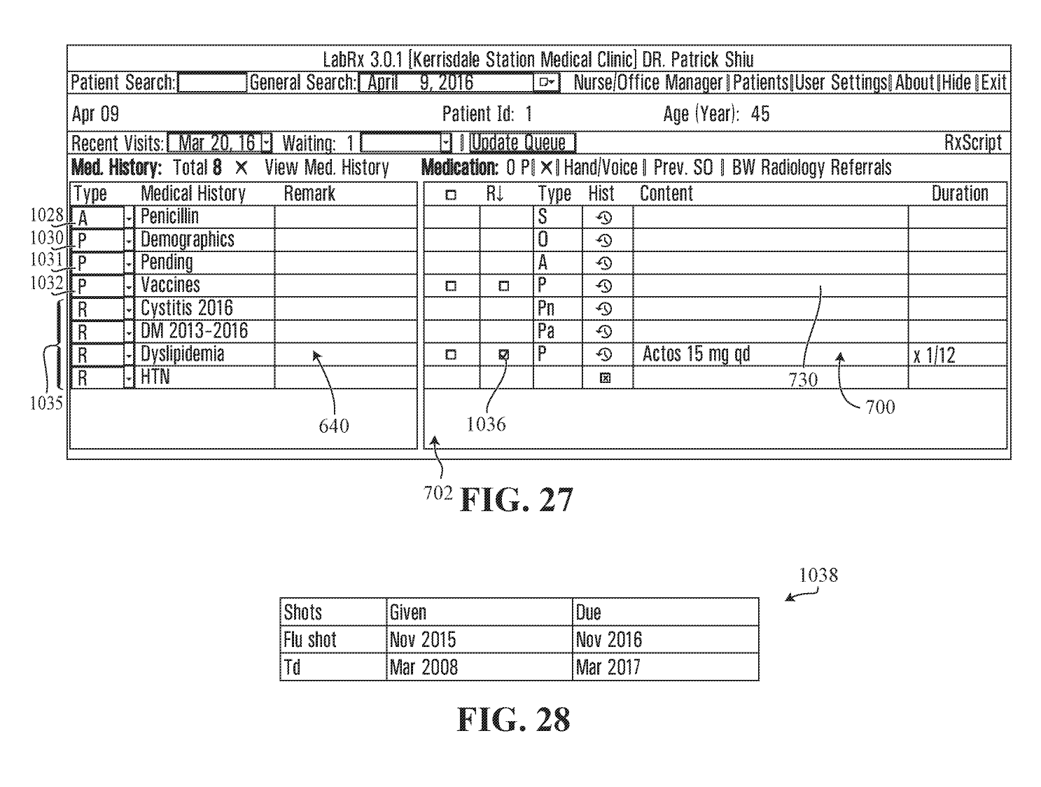

The charting interface page 570 also includes a medical history region 640. As illustrated in FIG. 16, after a patient is selected using the patient search input field 582 as described above, the user interface codes 550 (shown in FIG. 2) direct the microprocessor 150 to display medical history information (such as general state of health, past illness, past injury, past surgery, past hospitalization, current medication, allergy, immunization, substance abuse, or developmental history, for example, and may include any related remarks) of the selected patient. In the embodiment shown in FIG. 16, after the patient “John Doe” is selected, his medical history indicating a recurring condition (indicated by “R”) of “HTN” (representing hypertension) is retrieved from the chronic or recurring diseases field 240 of the instance of the patient table entry 222 and displayed in his medical history region 640. Allergies (indicated by “A”, for example) may also be retrieved from the allergies field 234 of the instance of the patient table entry 222 and displayed in the medical history region 640. As an example, an indication of an allergy (indicated by “A”) to penicillin is shown at 1028 in the medical history region 640 in FIG. 27. FIG. 27 also illustrates a demographics region 1030 in the medical history region 640. When the demographics region 1030 selected by a user, the demographics region 1030 may be expanded to display demographic information (such as name, age, sex, weight, height, alcohol drinking history, smoking history, habits, occupation, marital status, family history, and medication history, for example) retrieved from the demographics field 236 of the instance of the patient table entry 222.

The medical history region 640 may also include a pending action region 1031, and user selection of the a pending action region 1031 may retrieve a list of one or more pending actions for the current patient, such as a list of one or more specialist referrals awaiting reports, a repeated blood test in the future, or a follow-up with a specialist, for example.

After a patient associated with an instance of the patient table entry 222 is selected, the user interface codes 550 (shown in FIG. 2) direct the microprocessor 150 to execute create visit record program codes 680 stored in the program memory 156 (shown in FIG. 2). The create visit program codes 680 include codes for directing the microprocessor 150 (shown in FIG. 2) to create a new instance of the visit record table entry 352 (shown in FIG. 13) in the visit record table 350 stored in the database 160 (shown in FIGS. 2 and 3), and to populate the fields of the new instance of the visit record table entry 352 by storing an identifier of the selected patient in the patient identifier field 356, by storing an identifier of the current user in the user identifier field 358, storing an identifier of the current clinic in the clinic identifier field 360, and by storing the date from the visit date selection field 584 in the visit date field 362.

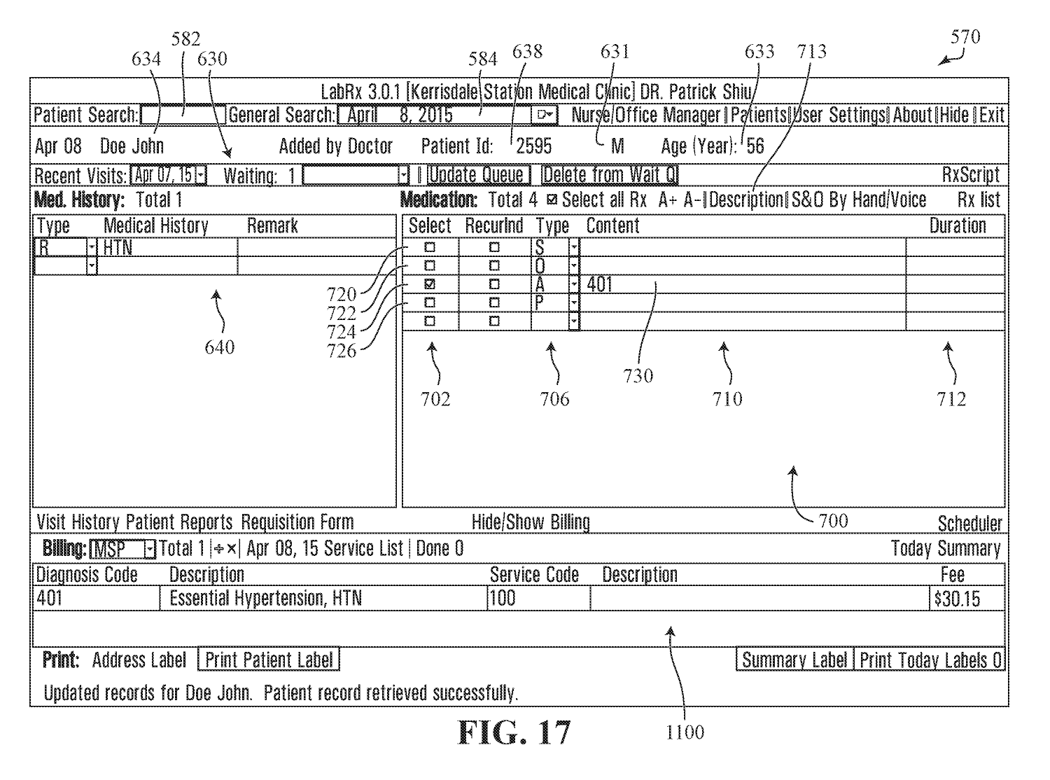

Referring to FIG. 17, the charting interface page 570 also includes a patient chart region 700 including a select column 702, a recurring indication column 704, a type column 706, a content column 710, and a duration column 712. After the create visit program codes 680 create the new instance of the visit record table entry 352, the patient chart region 700 includes various data input fields for charting in the electronic SOAP format discussed above, and more particularly the patient chart region 700 includes a subjective chart entry row 720 indicated by an “S” in the type column 706 for entry or display of a subjective component of an electronic SOAP note, an objective chart entry row 722 indicated by an “O” in the type column 706 for entry or display of an objective component of an electronic SOAP note, an assessment chart entry row 724 indicated by an “A” in the type column 706 for entry or display of an assessment component of an electronic SOAP note, and a treatment plan chart entry row 726 indicated by a “P” in the type column 706 for entry or display of a treatment plan component of an electronic SOAP note. The patient chart region 700 described above is the default electronic SOAP screen. Although the embodiment shown involves the electronic SOAP format, alternative embodiments may facilitate electronically documenting visits of patients in other formats.

Each of the rows 720, 722, 724, and 726 includes a respective input field in the content column 710, and in general the user may type or otherwise manually enter character sequences or other information in one or more of the input fields (by causing the microprocessor 150 to receive at least one manual entry input signal from one or more of the display screen 104, the keyboard 106, the trackpad 108, the mouse 110, and the microphone 112 shown in FIG. 1, for example) and in any order to document (or chart) a visit of a patient in SOAP format. Each of the rows 720, 722, 724, and 726 also includes a respective Boolean input field in the select column 702, and selection of the respective Boolean input field in the select column 702 indicates that the row is selected as a patient chart entry. In some embodiments, some rows will be automatically indicated as selected in the select column 702. For example, when the user enters or otherwise selects patient chart entries as described below, those patient chart entries may automatically be indicated as selected in the select column 702. However, some patient chart entries may automatically appear in the patient chart region 700 without being entered or otherwise selected by the user, and those patient chart entries may automatically be indicated as not selected in the select column 702. However, when a patient chart entry appears automatically and is not selected in the select column 702, the user may select such an entry, which may facilitate efficient selection of patient chart entries to document a visit of a patient.

In many cases, the user of the computer 102 (shown in FIGS. 1 and 2) will have previously entered chart entries for various different assessment codes, and allowing the user to retrieve chart entries that were previously entered in association with an assessment code may facilitate the user's task of documenting a patient visit. Further, allowing the user to retrieve chart entries that were previously entered in association with the user may allow the user to refer to a collection or library of previously entered patient chart entries that is personalized for the user. Therefore, before entering some or all subjective, objective, or treatment plan chart entries in the patient chart region 700, the user may enter an assessment code in an assessment content field 730 in the assessment row 724 and in the content column 710 by causing the microprocessor 150 (shown in FIG. 2) to receive at least one assessment code input signal representing user identification of the assessment code using at least one input device such as the display screen 104, the keyboard 106, the trackpad 108, the mouse 110, or the microphone 112. In some embodiments, a search page may be available to assist the user to identify an assessment code, for example by allowing the user to search descriptions of assessment codes in the assessment description field 276 of instances of the assessment code table entry 272 in the assessment code table 270. In the embodiment shown in FIG. 17, a user of the computer 102 has identified and inputted the assessment code “401” (representing hypertension) for the selected patient “John Doe” in the assessment content field 730. As shown in FIG. 17, the assessment chart entry row 724 is indicated as selected in the select column 702 because the user entered the assessment code “401” in the assessment content field 730 and, in the embodiment shown, a patient chart entry entered by the user is automatically indicated as selected in the select column 702.

In some cases, entry of an assessment code may automatically prompt a user to enter certain information. For example, entering the assessment code “401” (representing hypertension) may automatically prompt the user to enter a blood pressure measurement, and the entered blood pressure measurement may then be entered into the chart as an objective patient chart entry. As another example, entering the assessment code “250” (representing diabetes) may automatically prompt the user to enter blood measurement data.

More generally, after the user inputs the assessment code in the assessment content field 730, the user may select for user input any one of the subjective chart entry row 720, the objective chart entry row 722, and the treatment plan chart entry row 726, for example by using one or more of the display screen 104, the keyboard 106, the trackpad 108, and the mouse 110 to select the selected row for user input, and then select a “Description” button 713, which causes the microprocessor 150 to execute description program codes 900 that are stored in the program memory 156 (shown in FIG. 2) and that direct the microprocessor 150 to retrieve a plurality of previously entered patient chart entries stored in the database 160 (shown in FIGS. 2 and 3) in association with the assessment code in the assessment content field 730 and in association with the user.

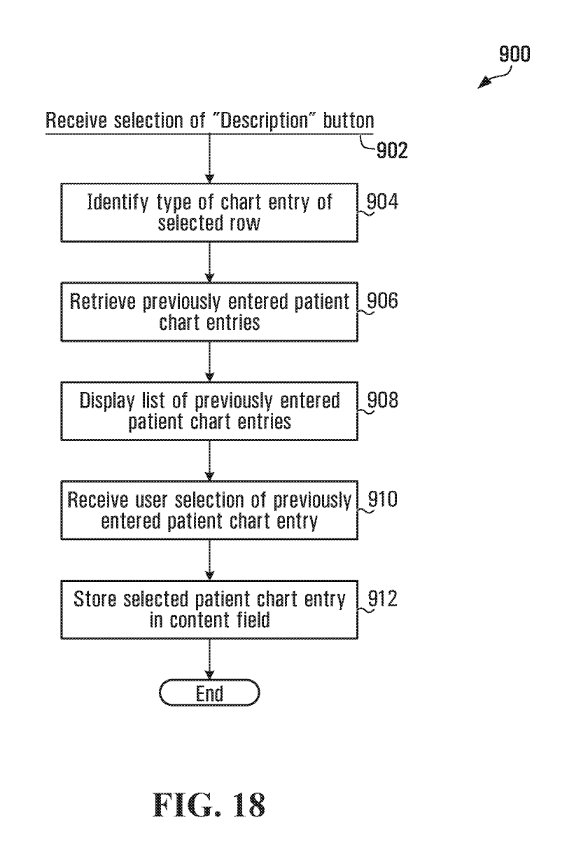

Referring to FIG. 18, the description program codes 900 begin at 902 in response to receiving signals indicating user selection of the “Description” button 713. The description program codes 900 then continue to block 904, which includes codes for directing the microprocessor 150 to identify a type of a selected row in the patient chart region 700. For example, if the user selects a subjective chart entry row such as the subjective chart entry row 720 for user input before selecting the “Description” button 713, then the codes at block 904 direct the microprocessor 150 to identify “subjective” as the selected row in the patient chart region 700. If instead the user selects an objective chart entry row such as the objective chart entry row 722 for user input before selecting the “Description” button 713, then the codes at block 904 direct the microprocessor 150 to identify “objective” as the selected row in the patient chart region 700. If instead the user selects a treatment chart entry row such as the treatment plan chart entry row 726 for user input before selecting the “Description” button 713, then the codes at block 904 direct the microprocessor 150 to identify “treatment plan” as the selected row in the patient chart region 700.

The description program codes 900 then continue to block 906, which includes codes for directing the microprocessor 150 to retrieve a plurality of previously entered patient chart entries from a table in the database 160. If, at block 904, the selected row in the patient chart region 700 was “subjective”, then the codes at block 906 direct the microprocessor 150 to retrieve a plurality of previously entered patient chart entries from the subjective information table 290 in the database 160. If instead, at block 904, the selected row in the patient chart region 700 was “objective”, then the codes at block 906 direct the microprocessor 150 to retrieve a plurality of previously entered patient chart entries from the objective data table 310 in the database 160. If instead, at block 904, the selected row in the patient chart region 700 was “treatment plan”, then the codes at block 906 direct the microprocessor 150 to retrieve a plurality of previously entered patient chart entries from the treatment plan table 330 in the database 160.

In the embodiment shown, the codes at block 906 direct the microprocessor 150 to retrieve, from the aforementioned table in the database 160, a plurality of previously entered patient chart entries that are associated with the assessment code in the assessment content field 730 (because the assessment code in the assessment content field 730 matches the assessment code in the assessment code field 298, 318, or 340) and that are associated with the current user (because the user identifier of the current user matches the user identifier in the user identifier field 300, 320, or 341). However, in alternative embodiments, association with the current user may not be required, and in such embodiments the codes at block 906 may simply direct the microprocessor 150 to retrieve, from the aforementioned table in the database 160, a plurality of previously entered patient chart entries that are associated with the assessment code in the assessment content field 730 (shown in FIG. 17).

Because the codes at block 906 direct the microprocessor 150 to retrieve, from the aforementioned table in the database 160, a plurality of previously entered patient chart entries that are associated with the current user, different users may associate identical previously entered patient chart entries with different assessment codes. For example, one user may associate penicillin with the assessment code “463” (an ICD-9 code identifying tonsillitis), and another user may associate penicillin with the assessment code “521” (an ICD-9 code identifying tooth infection). Therefore, embodiments such as those described herein may allow each user to access a personalized electronic collection or library of previously entered patient chart entries for a particular assessment code, which may associate a previously entered patient chart entry with a different assessment code than another user. Allowing a healthcare professional to re-use an electronically stored personal lexicon or library in a computer-implemented system that stores and retrieves specific past electronic patient chart entries entered by the healthcare professional may be more efficient or intuitive than a route-based series of diagnostic questions to document visits of patients common in other electronic documentation methods and systems.

In alternative embodiments, the codes at block 906 may direct the microprocessor 150 to retrieve, from the aforementioned table in the database 160, a plurality of previously entered patient chart entries that are associated with the assessment code in the assessment content field 730 and that additionally satisfy at least one other criterion. For example, one plurality of previously entered patient chart entries may be associated with a particular assessment code for patients in one age range, and a different plurality of previously entered patient chart entries may be associated with the same assessment code but for patients in a different age range.

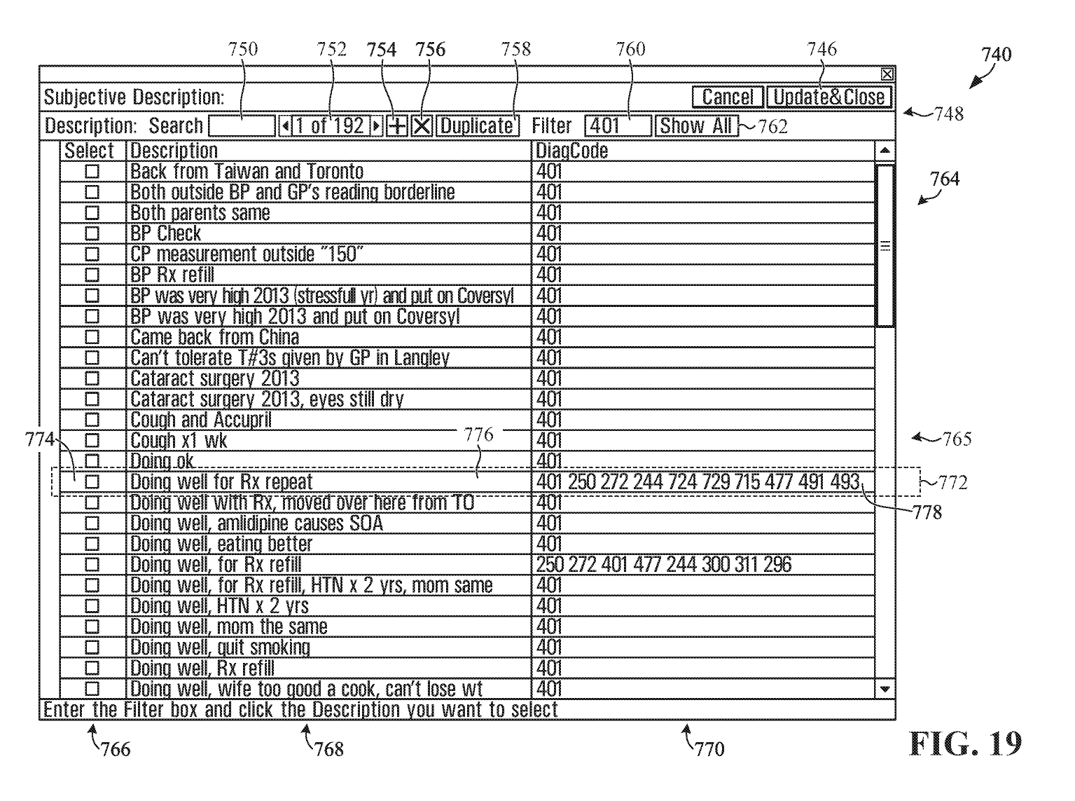

The description program codes 900 then continue to block 908, which includes codes for directing the microprocessor 150 to display the previously entered patient chart entries that were retrieved at block 906. If, at block 904, the selected row in the patient chart region 700 was “subjective”, then the codes at block 908 direct the microprocessor 150 to cause the display screen 104 (shown in FIG. 1) to display a subjective description page shown generally at 740 in FIG. 19.

Referring to FIG. 19, the subjective description page 740 includes a list region 764, which displays the previously entered patient chart entries, that were retrieved at block 906 from instances of the subjective information table entry 292 in the subjective information table 290, in respective rows in a plurality of rows shown generally at 765. Additionally, the list region 764 includes a “Select” column 766, a “Description” column 768, and a “DiagCode” column 770. The content displayed in the “Description” column 768 of a row in the list region 764 is retrieved from the subjective information description field 296 of the instance of the subjective information table entry 292 (shown in FIG. 8) represented by that row. Similarly, the content displayed in the “DiagCode” column 770 is retrieved from the assessment code field 298 of the instance of the subjective information table entry 292 represented by that row. For example, in the embodiment shown, a row 772 represents an instance of the subjective information table entry 292 and includes a description field 776 (in the “Description” column 768) indicating “Doing well for Rx repeat”, which is a previously entered subjective information patient chart entry stored in the subjective information description field 296 of the instance of the subjective information table entry 292 represented by the row 772. Similarly, the row 772 includes an assessment code field 778 (in the “DiagCode” column 770) indicating “401 250 272 244 724 729 715 477 491 493”, which are the assessment codes stored in the assessment code field 298 of the instance of the subjective information table entry 292 represented by the row 772.

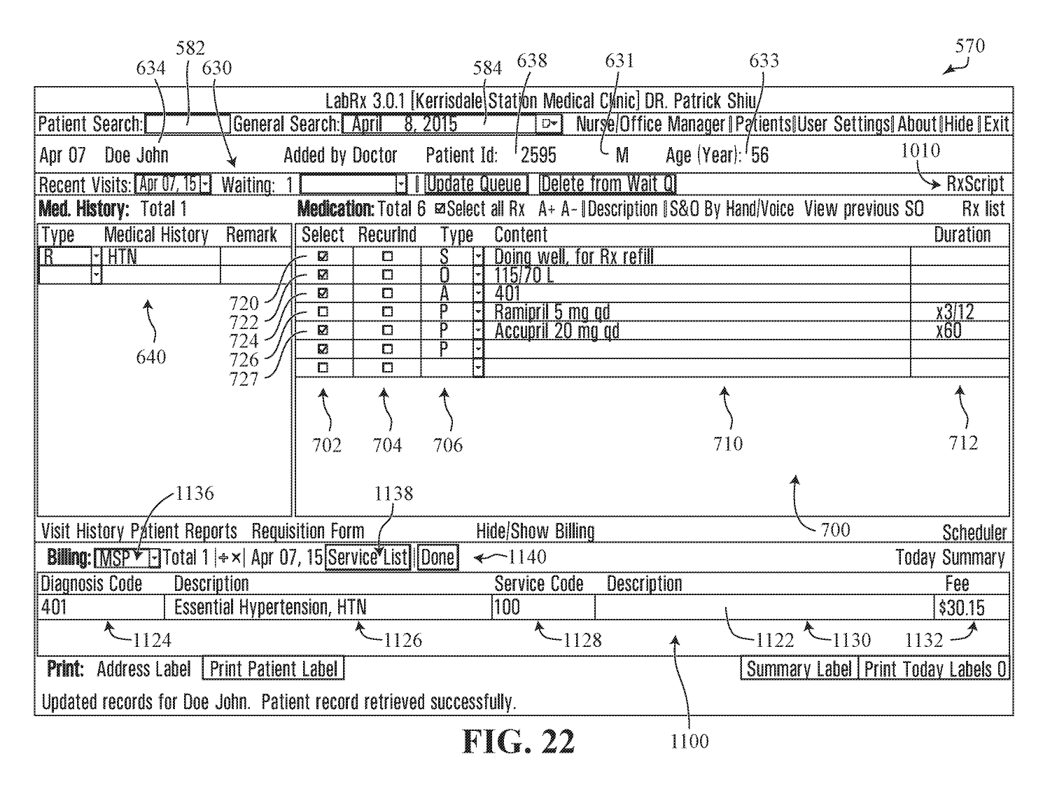

The subjective description page 740 also includes an “Update & Close” button 746. After the user selects one or more of the rows 765, selection of the “Update & Close” button 746 causes the one or more previously entered subjective information patient chart entries represented by the selected one or more of the rows 765 to be copied to respective rows for subjective information patient chart entries (identified by “S” in the type column 706) in the patient chart region 700 as shown in FIG. 22 for example. Specifically, each of the selected one or more of the rows 765 is associated with a respective instance of the subjective information table entry 292, and for each of the selected one or more of the rows 765, selection of the “Update & Close” button 746 directs the microprocessor 150 to retrieve the associated instance of the subjective information table entry 292, retrieve the previously entered subjective information patient chart entry from the subjective information description field 296 of the associated instance of the subjective information table entry 292, and store the previously entered subjective information patient chart entry in the content column 710 in a row for a subjective information patient chart entry (identified by “S” in the type column 706) in the patient chart region 700 as shown in FIG. 22 for example. Some embodiments may include, in each of the rows 765, a select and exit field that, if selected, selects the row and closes the subjective description page 740 so that a single selection can have the effect of selecting a row and selecting the “Update & Close” button 746.

The subjective description page 740 also includes a list management region 748 including a general search field 750, page navigator buttons 752, an add button 754, a delete button 756, a duplicate button 758, a filter field 760, and a “Show All” button 762. The list region 764 initially displays instances of the subjective information table entry 292 associated with the assessment code in the assessment content field 730 (shown in FIG. 17) and associated with the current user as described above regarding block 906. However, the user can also specify different criteria for selection of instances of the subjective information table entry 292 to be displayed in the list region 764. For example, the user can input text or other information into the general search field 750 to search for content stored in any of the fields of instances of the subjective information table entry 292. Also, the filter field 760 initially indicates the assessment code that was used at block 906 to retrieve the plurality of previously entered patient chart entries from the database 160 (shown in FIGS. 2 and 3), but the user may enter a different assessment code in the filter field 760 to cause the microprocessor 150 to display instead a different plurality of instances of the subjective information table entry 292 stored in the database 160 in association with the different assessment code. The user can also select the “Show All” button 762 to cause the microprocessor 150 to display representations of all instances of the subjective information table entry 292 within the subjective information table 290 (shown in FIG. 3), or of all instances of the subjective information table entry 292 that are associated with the current user. Additionally, the user can cause the DBMS codes 159 (shown in FIG. 2) to create a new instance of the subjective information table entry 292 by selecting the add button 754, delete an existing instance of the subjective information table entry 292 by selecting the existing instance in the “Select” column 766 and then selecting the delete button 756, or duplicate an existing instance of the subjective information table entry 292 by selecting the existing instance in the “Select” column 766 and then selecting the duplicate button 758. The user can also use the page navigator buttons 752 to scroll through different pages of the rows 765.

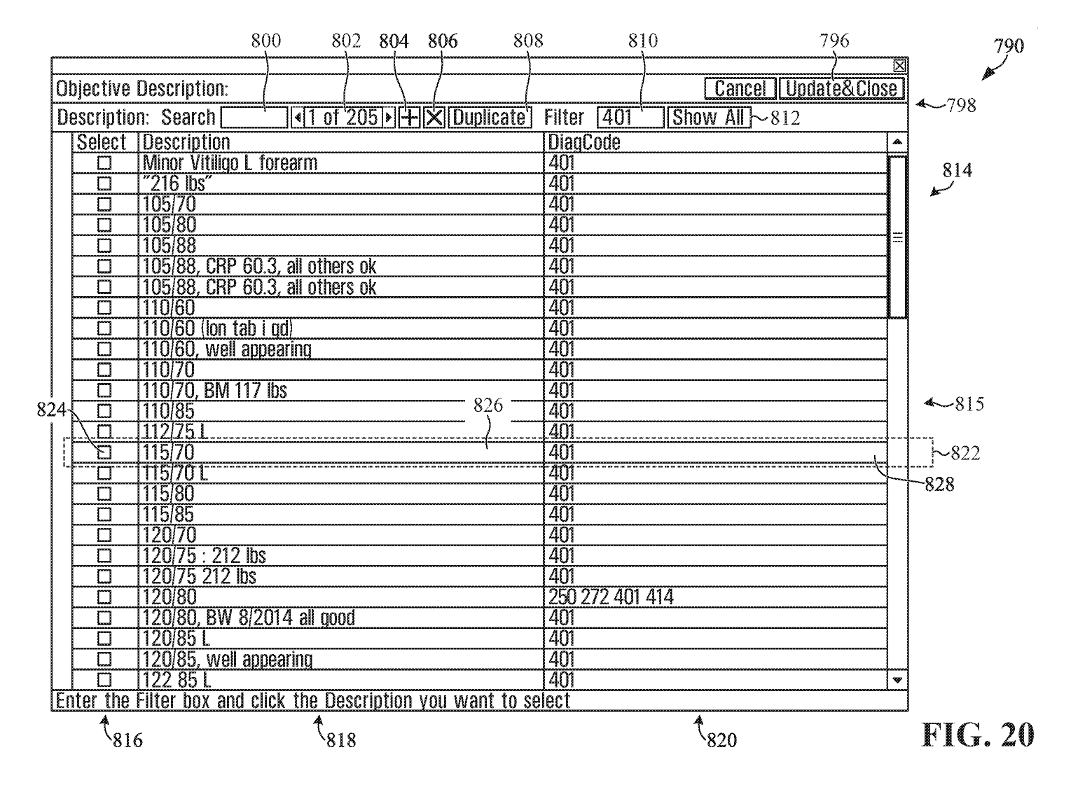

If instead, at block 906, the user selects the objective chart entry row 722 (shown in FIG. 17) for user input before selecting the “Description” button 713, then the codes at block 908 direct the microprocessor 150 to cause the display screen 104 to display an objective description page shown generally at 790 in FIG. 20.

Referring to FIG. 20, the objective description page 790 includes a list region 814, which displays the previously entered patient chart entries, that were retrieved at block 906 from instances of the objective data table entry 312 in the objective data table 310, in respective rows in a plurality of rows shown generally at 815. The list region 814 includes a “Select” column 816, a “Description” column 818, and a “DiagCode” column 820. The content displayed in the “Description” column 818 of a row in the list region 814 is retrieved from the objective data description field 316 (shown in FIG. 9) of the instance of the objective data table entry 312 represented by that row. Similarly, the content displayed in the “DiagCode” column 820 is retrieved from the assessment code field 318 of the instance of the objective data table entry 312 represented by that row. For example, in the embodiment shown, a row 822 represents an instance of the objective data table entry 312 and includes a description field 826 (in the “Description” column 818) indicating “115/70 L”, which is a previously entered objective data patient chart entry stored in the objective data description field 316 of the instance of the objective data table entry 312 represented by the row 822. Similarly, the row 822 includes an assessment code field 828 (in the “DiagCode” column 820), which indicates the assessment code “401” stored in the stored the assessment code field 318 of the instance of the objective data table entry 312 represented by the row 822.

The objective description page 790 also includes an “Update & Close” button 796. After the user selects one or more of the rows 815, selection of the “Update & Close” button 796 causes the one or more previously entered objective data patient chart entries represented by the selected one or more of the rows 815 to be copied to respective rows for objective data patient chart entries (identified by “O” in the type column 706) in the patient chart region 700 as shown in FIG. 22 for example. Specifically, each of the selected one or more of the rows 815 is associated with a respective instance of the objective data table entry 312, and for each of the selected one or more of the rows 815, selection of the “Update & Close” button 796 directs the microprocessor 150 to retrieve the associated instance of the objective data table entry 312, retrieve the previously entered objective data patient chart entry from the objective data description field 316 of the associated instance of the objective data table entry 312, and store the previously entered objective data patient chart entry in the content column 710 in a row for an objective data patient chart entry (identified by “O” in the type column 706) in the patient chart region 700 as shown in FIG. 22 for example. Some embodiments may include, in each of the rows 815, a select and exit field that, if selected, selects the row and closes the objective description page 790 so that a single selection can have the effect of selecting a row and selecting the “Update & Close” button 796.

The objective description page 790 also includes a list management region 798 including a general search field 800, page navigator buttons 802, an add button 804, a delete button 806, a duplicate button 808, a filter field 810, and a “Show All” button 812. The list region 814 initially displays instances of the objective data table entry 312 associated with the assessment code in the assessment content field 730 (shown in FIG. 17) and associated with the current user as described above regarding block 906. However, the user can also specify different criteria for selection of instances of the objective data table entry 312 to be displayed in the list region 814. For example, the user can input text or other information into the general search field 800 to search for content stored in any of the fields of instances of the objective data table entry 312. Also, the filter field 810 initially indicates the assessment code that was used at block 906 to retrieve the plurality of previously entered patient chart entries from the database 160 (shown in FIGS. 2 and 3), but the user can enter a different assessment code in the filter field 810 to cause the microprocessor 150 to display instead a different plurality of instances of the objective data table entry 312 stored in the database 160 in association with the different assessment code. The user can also select the “Show All” button 812 to cause the microprocessor 150 to display representations of all instances of the objective data table entry 312, or of all instances of the objective data table entry 312 that are associated with the current user. Additionally, the user can cause the microprocessor 150 to create a new instance of the objective data table entry 312 by selecting the add button 804, delete an existing instance of the objective data table entry 312 by selecting the row representing the instance in the “Select” column 816 and then selecting the delete button 806, or duplicate an existing instance of the objective data table entry 312 by selecting the instance in the “Select” column 816 and then selecting the duplicate button 808. The user can also use the page navigator buttons 802 to scroll through different pages of the rows 815.

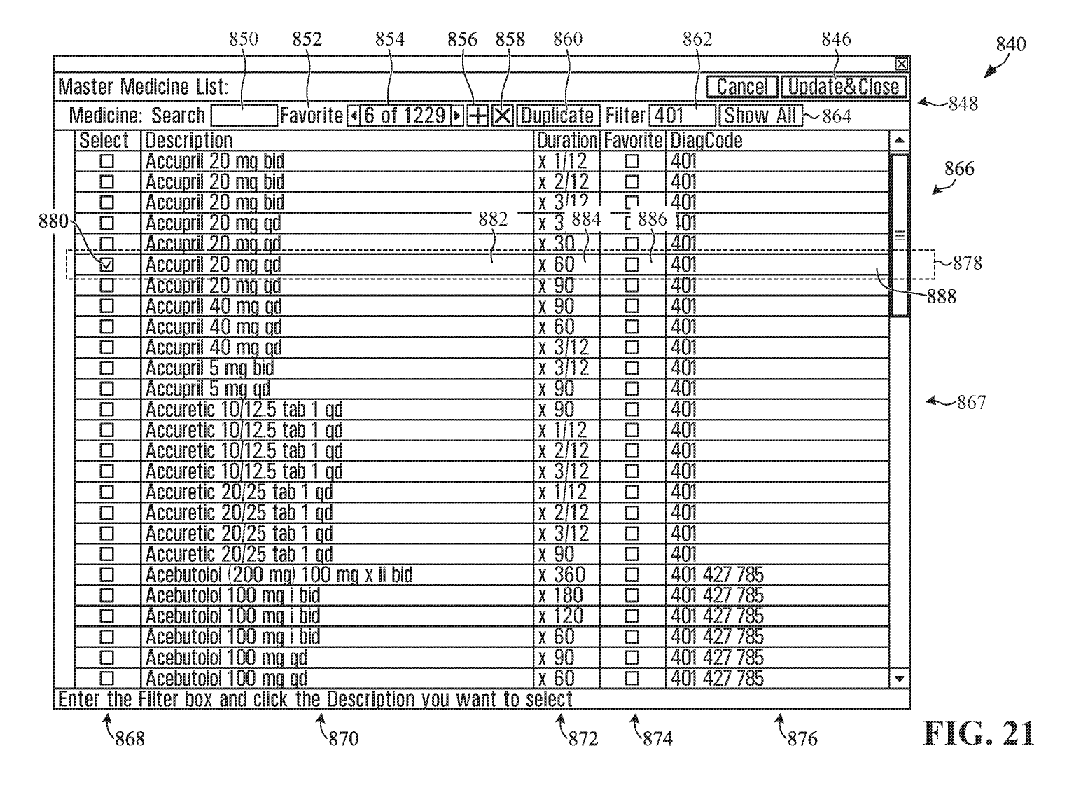

If instead, at block 906, the user selects the treatment plan chart entry row 726 (shown in FIG. 17) for user input before selecting the “Description” button 713, then the codes at block 908 direct the microprocessor 150 to cause the display screen 104 to display a master medicine list page shown generally at 840 in FIG. 21. Referring to FIG. 21, the master medicine list page 840 includes a list region 866, which displays the previously entered patient chart entries, that were retrieved at block 906 from instances of the treatment plan table entry 332 in the treatment plan table 330, in respective rows in a plurality of rows shown generally at 867. The list region 866 includes a “Select” column 868, a “Description” column 870, a “Duration” column 872, a “Favorite” column 874, and a “DiagCode” column 876. The content displayed in the “Description” column 870 of a row in the list region 866 is retrieved from the treatment plan description field 336 (shown in FIG. 10) of the instance of the treatment plan table entry 332 represented by that row. The content displayed in the “Duration” column 872 of a row in the list region 866 is retrieved from the treatment duration field 338 of the instance of the treatment plan table entry 332 represented by that row. The content displayed in the “Favorite” column 874 of a row in the list region 866 is retrieved from the favorite field 342 of the instance of the treatment plan table entry 332 represented by the row. For example, in the embodiment shown, if the instance of the treatment plan table entry 332 stores “TRUE” in the favorite field 342, a row representing that instance will display a check in its “Favorite” column 874 and will appear above non-favorites in the list region 866. In the embodiment shown, the non-favorites are listed alphabetically. The content displayed in the “DiagCode” column 876 of a row in the list region 866 is retrieved from the assessment code field 340 of the instance of the treatment plan table entry 332 represented by that row.

For example, in the embodiment shown, a row 878 represents an instance of the treatment plan table entry 332 (shown in FIG. 10) and includes a “Description” field 882 (in the “Description” column 870) indicating “Accupril 20 mg qd”, which is a previously entered treatment plan patient chart entry stored in the treatment plan description field 336 (shown in FIG. 10). The row 878 also includes a duration field 884 (in the “Duration” column 872) indicating “×60”, which is also a previously entered treatment plan patient chart entry, and more specifically a treatment duration stored in the treatment duration field 338 (shown in FIG. 10) of the instance of the treatment plan table entry 332 represented by the row 878. The row 878 also includes a favorite field 886 (in the “Favorite” column 874) indicating “FALSE” from the content stored in the favorite field 342 of the instance of the treatment plan table entry 332 represented by the row 878. However, the user may select the favorite field 886 to indicate that the treatment plan table entry 332 represented by the row 878 is a favorite. Therefore, user selection of the favorite field 886 causes the favorite field 342 of the instance of the treatment plan table entry 332 represented by the row 878 to be set to “TRUE”, and more generally instances of the treatment plan table entry 332 may be identified as favorites by selecting favorite fields in the “Favorite” column 874. The row 878 also includes an assessment code field 888 (in the “DiagCode” column 876), which indicates the assessment code “401” stored in the assessment code field 340 of the instance of the treatment plan table entry 332 represented by the row 878. As another example, entering an assessment code indicating a vaccination (such as the ICD-9 code “V05” or “V05.9”) may cause the list region 866 to include vaccines previously entered and stored in association with the vaccination assessment code.

The master medicine list page 840 also includes an “Update & Close” button 846. After the user selects one or more of the rows 867, selection of the “Update & Close” button 846 causes the one or more previously entered treatment plan patient chart entries represented by the selected one or more of the rows 867 to be copied to respective rows for treatment plan patient chart entries (identified by “P” in the type column 706) in the patient chart region 700 as shown in FIG. 22 for example. Specifically, each of the selected one or more of the rows 867 is associated with a respective instance of the treatment plan table entry 332, and for each of the selected one or more of the rows 867, selection of the “Update & Close” button 846 directs the microprocessor 150 to retrieve the associated instance of the treatment plan table entry 332, retrieve the previously entered treatment plan patient chart entry from the treatment plan description field 336 of the associated instance of the treatment plan table entry 332, retrieve the treatment duration information from the treatment duration field 338 of the associated instance of the treatment plan table entry 332, and in a row for a treatment plan patient chart entry (identified by “P” in the type column 706) in the patient chart region 700, store the previously entered treatment plan patient chart entry in the content column 710 and store the retrieved treatment duration information in the duration column 712, as shown in FIG. 22 for example. Some embodiments may include, in each of the rows 867, a select and exit field that, if selected, selects the row and closes the master medicine list page 840 so that a single selection can have the effect of selecting a row and selecting the “Update & Close” button 846.

The master medicine list page 840 also includes a list management region 848 including a general search field 850, a favorite button 852, page navigator buttons 854, an add button 856, a delete button 858, a duplicate button 860, a filter field 862, and a “Show All” button 864. The list region 866 initially displays instances of the treatment plan table entry 332 associated with the assessment code in the assessment content field 730 (shown in FIG. 17) and associated with the current user as described above regarding block 906. However, the user can also specify different criteria for selection of instances of the treatment plan table entry 332 to be displayed in the list region 866. For example, the user can input text or other information into the general search field 850 to search for content stored in any of the fields of instances of the treatment plan table entry 332. The user can use the favorite button 852 to cause the list region 866 to display only instances of the treatment plan table entry 332 that store “TRUE” in their favorite field 342. Also, the filter field 862 initially indicates the assessment code that was used at block 906 to retrieve the plurality of previously entered patient chart entries from the database 160 (shown in FIGS. 2 and 3), but the user can enter a different assessment code in the filter field 862 to cause the microprocessor 150 to display instead a different plurality of instances of the treatment plan table entry 332 stored in the database 160 in association with the different assessment code. The user can also select the “Show All” button 864 to cause the microprocessor 150 to display representations of all instances of the treatment plan table entry 332, or of all instances of the treatment plan table entry 332 that are associated with the current user. Additionally, the user can cause the DBMS codes 159 to create a new instance of the treatment plan table entry 332 by selecting the add button 856, delete an existing instance of the treatment plan table entry 332 by selecting the row representing the existing instance in the “Select” column 868 and then selecting the delete button 858, or duplicate an existing instance of the treatment plan table entry 332 by selecting the existing instance in the “Select” column 868 and then selecting the duplicate button 860. The user can also use the page navigator buttons 854 to scroll through different pages of the rows 867.

In some embodiments, patient chart entries indicating prescriptions of medication can be entered without using the master medicine list page 840, for example by selecting one or more patient chart entries that may automatically appear in the patient chart region 700. For example, in some embodiments, a treatment plan patient chart entry (identified by “P” in the type column 706) may be indicated as a recurring indication in the recurring indication column 704. For example, acetylsalicylic acid (commonly known as “ASA” or as “Asprin”) may be a recurring prescription for a patient diagnosed with heart disease, and ASA may be indicated as a recurring indication for a patient with heart disease. The user may indicate a recurring indication for a particular patient by selecting the Boolean input field in the recurring indication column 704 of a patient chart entry of that patient. As an example, a recurring indication of “Actos 15 mg qd” is shown at 1036 in FIG. 27. When a treatment plan patient chart entry is indicated as a recurring indication for a particular patient, the treatment plan patient chart entry may appear automatically in a row patient chart region 700 during a visit by that patient. In the embodiment shown, patient chart entries that automatically appear in the patient chart region 700, without being entered or otherwise selected by the user, are automatically indicated as not selected in the select column 702, but the user may select such an entry, for example either by selection of the respective Boolean input field in the select column 702 or by otherwise editing the entry. Therefore, if a patient is prescribed a recurring prescription, for example, then in some embodiments the recurring prescription will appear automatically in the patient chart region 700 during a visit by that patient, and the user may prescribe the recurring prescription simply by selecting (in the select column 702) the patient chart entry (which may appear automatically in the patient chart region 700) for the recurring prescription.

Further, in some embodiments, a previously entered treatment plan patient chart entry (identified by “P” in the type column 706) may appear automatically for a prescription that was previously entered for the same assessment code, either for the same patient or for a demographically similar patient (such as a patient having the same gender, a similar age, or both, for example). For example, if a patient is prescribed a prescription (penicillin, for example) for an assessment code (for example, tonsillitis having an ICD-9 assessment code “463”) and an instance of the visit record table entry 352 (shown in FIG. 13) associates that prescription (as identified in the treatment plan description field 412) with that assessment code (as identified the assessment code field 398) for that patient (as identified in the patient identifier field 356), then on a subsequent visit of that patient, if that assessment code (“463” for example) is entered, then a treatment plan patient chart entry (identified by “P” in the type column 706) may automatically appear for the same prescription (penicillin, for example). In some embodiments, if an assessment code for a particular patient is entered but no visit record table entry 352 associates that assessment code with any previously entered treatment plan patient chart entry for that patient, then a treatment plan patient chart entry (identified by “P” in the type column 706) may automatically appear if a previously entered treatment plan patient chart entry associates that assessment code with that treatment plan patient chart entry for a demographically similar patient (such as a patient having the same gender, a similar age, or both, for example). Such automatically appearing patient chart entries from previously entered treatment plan patient chart entry for demographically similar patients may be optional in some embodiments. Again, in the embodiment shown, patient chart entries that automatically appear in the patient chart region 700, without being entered or otherwise selected by the user, are automatically indicated as not selected in the select column 702, but the user may select such an entry (for example either by selection of the respective Boolean input field in the select column 702 or by otherwise editing the entry) if the user decides to prescribe the same medication (penicillin in the example above) for the same condition (tonsillitis in the example above). Therefore, if a patient returns with a repeated condition or has a condition (such as tonsillitis, for example) for which a demographically similar patient received a previous prescription, then the user may prescribe the same prescription as before simply by selecting (in the select column 702) the patient chart entry (which may appear automatically in the patient chart region 700) for the previous prescription for that condition.

Although the embodiment shown in FIG. 21 includes prescription drugs, alternative embodiments may include other possible treatment plan patient chart entries, such as a procedure performed or to be performed, referral to a specialist, referral to another clinic or to a hospital, further laboratory or diagnostic tests, a note or a letter of the healthcare provider, patient education, or patient instruction, for example.

For example, in some embodiments, an assessment code “250” (an ICD-9 code identifying diabetes) may be associated with some such other treatment plan patient chart entries in the treatment plan table 330 in the database 160. In such embodiments, once “250” is entered in the assessment content field 730 and an “Investigation” button (not shown) is selected, then the previously entered patient chart entries that the microprocessor 150 retrieves at block 906 from the treatment plan table 330, and the previously entered patient chart entries that would be displayed for user selection, may be only investigation treatment plan patient chart entries (such as scanned-stored blood sugar results) that are associated with the assessment code “250” in the treatment plan table 330. Also, in such embodiments, once “250” is entered in the assessment content field 730 and a “Referral” button (not shown) is selected, then the previously entered patient chart entries that the microprocessor 150 retrieves at block 906 from the treatment plan table 330, and the previously entered patient chart entries that that would be displayed for user selection, may be only referral treatment plan patient chart entries (such as a referral to a diabetologist) that are associated with the assessment code “250” in the treatment plan table 330.

As another example, in some embodiments, an assessment code “919” (an ICD-9 code identifying an injury) may be associated with some such other treatment plan patient chart entries in the treatment plan table 330. In such embodiments, once “919” is entered in the assessment content field 730 and the “Investigation” button is selected, then the previously entered patient chart entries that the microprocessor 150 retrieves at block 906 from the treatment plan table 330, and the previously entered patient chart entries that would be displayed for user selection, may be only investigation treatment plan patient chart entries (such as x-ray reports and not blood tests) that are associated with the assessment code “919” in the treatment plan table 330. Also, in such embodiments, once “919” is entered in the assessment content field 730 and the “Referral” button is selected, then the previously entered patient chart entries that the microprocessor 150 retrieves at block 906 from the treatment plan table 330, and the previously entered patient chart entries that that would be displayed for user selection, may be only referral treatment plan patient chart entries (such as a referral to an orthopedic surgeon and not referral to a diabetologist) that are associated with the assessment code “919” in the treatment plan table 330.

As indicated above, alternative embodiments may include further classification of treatment plan patient chart entries such classification into categories indicated as “P”, as “Pa”, and as “Pn” as described above. In such embodiments, the user may select one of “P”, “Pa”, and “Pn” for a patient chart entry, and such a selection may select a subset of previously entered treatment plan patient chart entries to narrow down the previously entered treatment plan patient chart entries available for selection. For example, if the user would like to chart advice given, then the user may select “Pa” for a patient chart entry, and then the user will in some embodiments be able to select from previously entered treatment plan patient chart entries, that are classified as advice, and that are stored in association with an assessment code as described above. In doing so, the user may select from among previously entered treatment plan patient chart entries that are classified as advice and that are stored in association with an assessment code, instead of from among all previously entered treatment plan patient chart entries (including drug prescriptions and notes, for example) that are stored in association with an assessment code, and selecting from among such a subset of previously entered treatment plan patient chart entries may be more convenient or efficient.

Further, in some embodiments, previously entered patient chart entries, other than treatment plan patient chart entries, may automatically appear in the patient chart region 700. For example, in some embodiments, the patient chart region 700 may automatically display all of the patient chart entries from the most recent visit of the same patient, or some of the patient chart entries from the most recent visit of the same patient, for example such as some or all of any “S” entries from the most recent visit of the same patient, some or all of any “O” entries from the most recent visit of the same patient, the “A” entry from the most recent visit of the same patient, or some or all of any “P” entries from the most recent visit of the same patient, or any combination thereof. Again, in the embodiment shown, patient chart entries that automatically appear in the patient chart region 700, without being entered or otherwise selected by the user, are automatically indicated as not selected in the select column 702, but the user may select such any such entry that may apply to the current visit, for example either by selection of the respective Boolean input field in the select column 702 or by otherwise editing the entry.

Referring back to FIG. 18, after block 908, the description program codes 900 proceed to block 910, which includes codes for directing the microprocessor 150 to receive at least one selection input signal (from one or more of the using at least one input device such as the display screen 104, the keyboard 106, the trackpad 108, the mouse 110, and the microphone 112 shown in FIG. 1) representing user selection of a previously entered patient chart entry from the subjective description page 740 shown in FIG. 19 (if at block 904 the user selected a subjective chart entry row such as the subjective chart entry row 720 shown in FIG. 17 for user input before selecting the “Description” button 713), from the objective description page 790 shown in FIG. 20 (if at block 904 the user selected an objective chart entry row such as the objective chart entry row 722 shown in FIG. 17 for user input before selecting the “Description” button 713), or from the master medicine list page 840 shown in FIG. 21 (if at block 904 the user selected a treatment chart entry row such as the treatment plan chart entry row 726 shown in FIG. 15 for user input before selecting the “Description” button 713). For example, the user may select such a previously entered patient chart entry using fields in the “Select” column 766, the “Select” column 816, or in the “Select” column 868.

After block 910, the description program codes 900 proceed to block 912, which includes codes for directing the microprocessor 150 to enter one or more previously entered patient chart entries (identified at block 910) automatically in data input fields in the patient chart region 700 (shown in FIG. 22). For example, in the embodiment shown in FIG. 22, the user selected a select field 774 (shown in FIG. 19) in the row 772, and subsequent selection of the “Update & Close” button 746 caused “Doing well for Rx repeat” (from the description field 776 in the row 772) to be entered automatically in the content column 710 in the subjective chart entry row 720 as shown in FIG. 22. Also, in the embodiment shown, the user selected a select field 824 (shown in FIG. 20) in the row 822, and subsequent selection of the “Update & Close” button 796 caused “115/70 L” (from the description field 826 in the row 822) to be entered automatically in the content column 710 in the objective chart entry row 722 as shown in FIG. 22. Also, in the embodiment shown, the user selected a select field 880 (shown in FIG. 21) in the row 878, and subsequent selection of the “Update & Close” button 846 caused “Accupril 20 mg qd” (from the “Description” field 882 in the row 878) to be entered automatically in the content column 710 in the treatment plan chart entry row 727, and which caused “×60” (from the duration field 884 in the row 878) to be entered automatically in the duration column 712 in the treatment plan chart entry row 727, as shown in FIG. 22. As shown in FIG. 22, the subjective chart entry row 720, the objective chart entry row 722, and the treatment plan chart entry row 727 are indicated as selected in the select column 702 because the user selected previously entered patient chart entries for those rows and, in the embodiment shown, a patient chart entry selected by the user is automatically indicated as selected in the select column 702. The description program codes 900 end after block 912.

The embodiment shown includes two treatment plan chart entry rows 726 and 727, and in general the patient chart region 700 can include any number of rows for subjective information patient chart entries (identified by “S” in the type column 706), any number of objective data patient chart entries (identified by “O” in the type column 706), and any number of treatment plan patient chart entries (identified by “P” in the type column 706), although in some embodiments a visit will be limited to a single diagnosis and thus limited to a single assessment chart entry row (identified by “A” in the type column 706).

In addition to automatic entry in data input fields in the patient chart region 700 as described above, the user may (as indicated above) type or otherwise manually enter character sequences or other information in one or more of the input fields (by causing the microprocessor 150 to receive at least one manual entry input signal from one or more of the display screen 104, the keyboard 106, the trackpad 108, the mouse 110, and the microphone 112 shown in FIG. 1, for example) and in any order to document (or chart) a visit of a patient in SOAP format. For example, in the embodiment shown, instead of using the master medicine list page 840, the user manually entered (using the one or more of the display screen 104, the keyboard 106, the trackpad 108, the mouse 110, and the microphone 112, for example) “Ramipril 5 mg qd” in the content column 710 in the treatment plan chart entry row 726 and “× 3/12” (meaning for three months) in the duration column 712 in the treatment plan chart entry row 726, as shown in FIG. 22. Of course in other embodiments, patient chart entries may be entered in the patient chart region 700 in various different combinations, for example by manually entering any number of subjective information patient chart entries, any number of objective data patient chart entries, any number of treatment plan patient chart entries, and by automatically entering any number of subjective information patient chart entries, any number of objective data patient chart entries, any number of treatment plan patient chart entries.

Further, in addition to automatic and manual entry in data input fields in the patient chart region 700 as described above, the user may (also by causing the microprocessor 150 to receive at least one manual entry input signal from one or more of the display screen 104, the keyboard 106, the trackpad 108, the mouse 110, and the microphone 112 shown in FIG. 1, for example) manually edit automatically entered information. For example, after “115/70 L” was automatically entered in the content column 710 in the objective chart entry row 722 as described above, the user may (as indicated above) type or otherwise manually edit “115/70 L” (using the one or more of the display screen 104, the keyboard 106, the trackpad 108, the mouse 110, and the microphone 112, for example) to another character sequence, such as “120/70 L” for example. More generally, automatically entered text in any of the input fields may be edited manually to document (or chart) a visit of a patient in SOAP format. Therefore, information in each of the input fields may be automatically entered, manually entered, or automatically entered and then manually edited.

Still further, instead of automatic or manual entry in data input fields in the patient chart region 700 as described above, the user may prefer creating one or more subjective information patient chart entries, or one or more objective data patient chart entries, or both, using one or more patient-specific audio recordings, one or more patient-specific video recordings, or both (using Microsoft™ OneNote™, for example). Therefore, in some embodiments, the user may use one or both of the microphone 112 and a video camera (not shown) to create one or more patient-specific audio recordings, one or more patient-specific video recordings, or both.

Referring to FIG. 27, the medical history region 640 may include medical history information (in addition to the medical history information described above) accumulated or organized according to medical history assessment codes, which are assessment codes (such as ICD-9 codes, for example) that may be associated with medical history information. For example, in some embodiments, medical history assessment codes may include vaccination assessment codes (such as the ICD-9 code “V05.9”), and when a patient has a history of vaccinations, the medical history region 640 may include a vaccination region 1032 that, when selected by a user, may be expanded to display a vaccination list, such as the vaccination list shown generally at 1038 in FIG. 28 for example.

To identify a history of vaccinations for a particular patient, the user interface codes 550 (shown in FIG. 2) may direct the microprocessor 150 to identify instances of the visit record table entry 352 (shown in FIG. 13) in which the patient identifier field 356 identifies the particular patient, and in which the assessment code field 398 identifies a vaccination (for example when the assessment code field 398 includes the ICD-9 code “V05.9”). The specific vaccines may be indicated in the objective data description field 402 of such instances of the visit record table entry 352. For example, in the embodiment shown in FIG. 28, such instances of the visit record table entry 352 included an instance identifying a flu vaccine in November 2015 and an instance identifying a tetanus vaccine in March 2008.

Further, in some embodiments, when an assessment code indicating a vaccination (such as the ICD-9 code “V05.9”) is entered in the assessment content field 730 (shown in FIG. 17), the vaccination region 1032 and the vaccination list 1038 may immediately reflect the vaccination even before an instance of the visit record table entry 352 is actually created to reflect the vaccination. Vaccination flow sheets or flow charts may also be retrieved when stored in association with assessment codes that identify a vaccination.

The medical history region 640 may also include a recurring medical condition region shown generally at 1035. In some embodiments, a user of the computer 102 (shown in FIGS. 1 and 2) may identify one or more particular medical conditions to be identified as recurring. For example, a psychiatrist may frequently encounter bipolar disorder and may identify an assessment code (such as the ICD-9 code “296” indicating bipolar disorder) as a medical history assessment code indicating a recurring medical condition. As another example, a general practitioner physician may frequently encounter diabetes, depression, and hypertension and may identify assessment codes (such as ICD-9 codes “250”, “311”, and “401” indicating diabetes, depression, and hypertension respectively) as medical history assessment codes indicating recurring medical conditions. However, in other embodiments, one or more particular medical conditions may be identified as recurring in other ways, and one or more medical history assessment codes may be identified in other ways.

When a patient's medical history includes medical history information associated with a medical history assessment code indicating a recurring medical condition, the recurring medical condition region 1035 includes a region indicating the recurring medical condition. For example, in the embodiment shown in FIG. 27, the user of the computer 102 indicated (at least) cystitis, diabetes, dyslipidemia, and hypertension as recurring medical conditions, and the patient recurring medical condition region 1035 indicates that the current patient has a history of (at least) cystitis, diabetes, dyslipidemia, and hypertension. To identify a history of recurring medical conditions for a particular patient, the user interface codes 550 (shown in FIG. 2) may direct the microprocessor 150 to identify instances of the visit record table entry 352 (shown in FIG. 13) in which the patient identifier field 356 identifies the particular patient, and in which the assessment code field 398 identifies a recurring medical condition as identified by the user of the computer 102.

Further, in some embodiments, when an assessment code indicating such a recurring medical condition is entered in the assessment content field 730, the recurring medical condition region 1035 may immediately reflect the recurring medical condition even before an instance of the visit record table entry 352 is actually created to reflect the recurring medical condition.

Rows in the recurring medical condition region 1035 may indicate a time period for a recurring medical condition. For example, in the embodiment shown in FIG. 27, at least one instance of the visit record table entry 352 identified the current patient (in the patient identifier field 356), identified cystitis (in the assessment code field 398), and was dated in 2016 (in the visit date field 362), so a row in the recurring medical condition region 1035 indicates “Cystitis 2016” to indicate a history of cystitis in 2016. Also, in the embodiment shown in FIG. 27, instances of the visit record table entry 352 identified the current patient (in the patient identifier field 356), identified diabetes (in the assessment code field 398), and were dated at least in 2013 and in 2016 (in the visit date field 362), so a row in the recurring medical condition region 1035 indicates “DM 2013-2016” to indicate a history of diabetes from 2013 to 2016.

Again, in some embodiments, when an assessment code indicating such a recurring medical condition is entered in the assessment content field 730, the recurring medical condition region 1035 may immediately reflect the recurring medical condition even before an instance of the visit record table entry 352 is actually created to reflect the recurring medical condition. Therefore, for example, if instances of the visit record table entry 352 identified the current patient (in the patient identifier field 356), identified diabetes (in the assessment code field 398), and were dated in 2013 (in the visit date field 362), then a row in the recurring medical condition region 1035 would initially indicate “DM 2013” (representing a history of diabetes in 2013), but entering an assessment code indicating diabetes (such as the ICD-9 code “250”) in the assessment content field 730 may immediately cause “DM 2013” to be updated to “DM 2013-2016” (representing a history of diabetes from 2013 to 2016).

User selection of a row in the recurring medical condition region 1035 may cause the recurring medical condition region 1035 to expand to indicate medical history information stored in the database 160 in association with the medical history assessment code indicating the selected recurring medical condition. Such medical history information may be identified from medical history information in instances of the visit record table entry 352 (shown in FIG. 13) in which the patient identifier field 356 identifies the particular patient, and in which the assessment code field 398 identifies the selected recurring medical condition. For example, such medical history information may be identified from one or more of the objective data description field 402, the treatment plan description field 412, and the treatment duration field 414 of such instances of the visit record table entry 352.

For example, user selection of “DM 2013-2016” in the recurring medical condition region 1035 may cause the recurring medical condition region 1035 to expand to indicate medical history information such as one or more body mass index (or “BMI”) readings, one or more blood pressure readings, one or more test results or laboratory reports (such as test results or laboratory reports relating to fasting blood sugar (“FBS”) measurements, other blood sugar measurements, A1C test results, albumin to creatinine ratio (“ACR”) test results, radiology reports such as a radiology report regarding a chest x-ray, or a nerves conduction test report, for example), reports from specialists or from specialist clinics, or a combination of some or all of BMI readings, blood pressure readings, test results, laboratory reports, and specialist reports stored in the database 160 in association with an assessment code indicating diabetes (such as the ICD-9 code “250”) in the objective data description field 402 of instances of the visit record table entry 352 in which the patient identifier field 356 identifies the particular patient, and in which the assessment code field 398 identifies diabetes.

As another example, the medical history information associated with a recurring medical condition may include advice provided and stored in the treatment plan description field 412 of such instances of the visit record table entry 352. For example, if during a previous patient visit for diabetes, the patient was advised to lose 30 pounds of body weight in the next three months, then a previously entered patient chart entry may be stored in the database 160 in an instance of the visit record table entry 352 in which the patient identifier field 356 identifies the particular patient, the assessment code field 398 identifies diabetes, and the treatment plan description field 412 includes “to lose 30 pounds in 3 months”. In such an example, user selection of “DM 2013-2016” in the recurring medical condition region 1035 may retrieve such an instance of the visit record table entry 352 and display such advice along with any other medical history information associated with a recurring medical condition as described herein.

As another example, user selection of “HTN” (representing hypertension) in the recurring medical condition region 1035 may cause the recurring medical condition region 1035 to expand to indicate medical history information associated with the recurring medical condition, such as one or more blood pressure readings stored in the database 160 in association with an assessment code indicating hypertension (such as the ICD-9 code “401”) in the objective data description field 402 of instances of the visit record table entry 352 in which the patient identifier field 356 identifies the particular patient, and in which the assessment code field 398 identifies hypertension.

Some recurring medical conditions may be interrelated, so selecting one recurring medical condition in the recurring medical condition region 1035 may retrieve medical history information stored in the database 160 in association with more than one assessment code. For example, user selection of “Dyslipidemia” in the recurring medical condition region 1035 may cause the recurring medical condition region 1035 to expand to indicate medical history information stored in the database 160 in association with either an assessment code indicating diabetes (such as the ICD-9 code “250”) or an assessment code indicating dyslipidemia (such as the ICD-9 code “272”) in the objective data description field 402 of instances of the visit record table entry 352 in which the patient identifier field 356 identifies the particular patient, and in which the assessment code field 398 identifies either hypertension or dyslipidemia.

In embodiments such as those described herein, the medical history region 640 may reflect a cumulative patient profile (“CPP”) relatively efficiently when compared to existing methods of electronically documenting patient visits. Some medical history information in the medical history region 640 (such as demographic information such as alcohol drinking history, smoking history, occupation, marital status, and medication history, for example) may be provided by a patient and entered by an assistant, but other medical history information in the medical history region 640 (such as a history of a recurring medical condition or medical history information associated with the recurring medical condition) may be accumulated according to medical history assessment codes, such as assessment codes indicating recurring medical conditions for example, and presented to a user. Accumulating such medical history information according to such medical history assessment codes may facilitate generation and maintenance of a patient's CPP more efficiently than existing methods of generating and maintaining a patient's CPP. The CPP field 238 of instances of the patient table entry 222 (shown in FIG. 6) may store such CPP information for different patients.

Further, in some embodiments, when drugs are prescribed for a medical condition identified by user of the computer 102 as recurring, such drugs may automatically appear in the patient chart region 700 without being entered or otherwise selected by the user. Drugs prescribed for a medical condition identified as recurring may be identified from the treatment plan description field 412 of instances of the visit record table entry 352 in which the patient identifier field 356 identifies the particular patient, and in which the assessment code field 398 identifies a recurring medical condition, for example as identified by the user of the computer 102. In the embodiment shown, patient chart entries that automatically appear in the patient chart region 700, without being entered or otherwise selected by the user, are automatically indicated as not selected in the select column 702, but the user may select such an entry, for example either by selection of the respective Boolean input field in the select column 702 or by otherwise editing the entry. Therefore, if a patient is prescribed a prescription for a medical condition identified as recurring, for example, then the prescription may appear automatically in the patient chart region 700 during a visit by that patient, and the user may prescribe the prescription simply by selecting (in the select column 702) the patient chart entry (which may appear automatically in the patient chart region 700) for the recurring prescription.

For example, in the embodiment shown in FIG. 27, a patient has a medical history of diabetes, which the user identified as a recurring medical condition, and the patient has previously been prescribed “Actos 15 mg qd” because at least one instance of the visit record table entry 352 identifies the patient in the patient identifier field 356, identifies diabetes in which the assessment code field 398, and includes “Actos 15 mg qd” in the treatment plan description field 412. The user of the computer 102 may therefore select “Actos 15 mg qd” in the select column 702 to prescribe “Actos 15 mg qd” again for the patient.

In summary, in some embodiments, the user interface codes 550 (shown in FIG. 2) may direct the microprocessor 150 to retrieve, from the database 160, instances of the visit record table entry 352 representing previously entered patient chart entries stored in the database 160 in association with one or more medical history assessment codes, such as one or more assessment codes representing vaccinations or one or more assessment codes representing medical conditions identified as recurring, to present medical history information (in addition to other medical history information such as other medical history information as described herein) accumulated or organized according to medical history assessment codes and presented in a medical history such as a patient's CPP that may be updated immediately when the user enters such an assessment code, and that may also represent medical history from previously entered patient chart entries that may be retrieved according to such assessment codes.

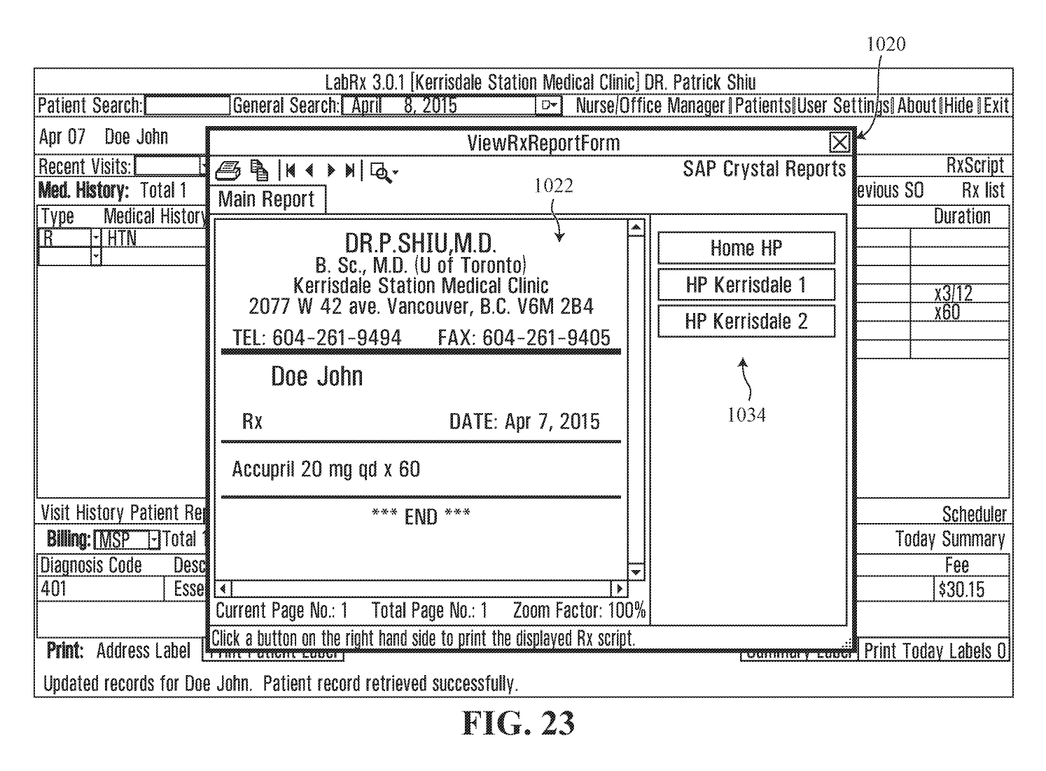

Referring to FIG. 22, the charting interface page 570 also includes an RxScript button 1010 to produce a prescription script. For example, in the embodiment shown, after causing “Accupril 20 mg qd” to be entered in the content column 710 in the treatment plan chart entry row 727 and after causing “×60” to be entered in the duration column 712 in the treatment plan chart entry row 727 as described above, selection of the RxScript button 1010 causes the microprocessor 150 to display, on the display screen 104, a prescription script interface shown generally at 1020 in FIG. 23. The prescription script interface 1020 includes a prescription script illustration shown generally at 1022 and a printer selection region shown generally at 1034. The user may select a printer using a printer button in the printer selection region 1034, and the user selection of a printer causes the selected printer (such as the printer 116 in the embodiment shown) to print a reproduction of the prescription script illustration 1022. In other embodiments, other documents (such as laboratory requisitions or referral letters) may be generated in response to treatment plan patient chart entries in the patient chart region 700. The charting interface page 570 also includes a “Print Patient Label” button that, if selected, causes the printer 116 to print a paper record of the patient chart entries if desired.

The charting interface page 570 also includes a billing region shown generally at 1100. The billing region 1100 includes a payor selector 1136 and may include various rows each representing a billing patient chart entry, such as a row 1122 in the embodiment shown.

The billing patient chart entry represented by the row 1122 includes a diagnosis code field 1124 indicating an assessment code, a description field 1126 indicating a description of the diagnosis represented by the diagnosis code in the diagnosis code field 1124, a service code field 1128 indicating a code for a billable service, a second description field 1130 indicating a description of the billable service represented by the service code in the service code field 1128, and a fee field 1132 indicating a fee for the billable service represented by the service code in the service code field 1128.

The diagnosis code field 1124, the description field 1126, the service code field 1128, the second description field 1130 and the fee field 1132 may be entirely automatically populated, partially automatically populated and partially selected, or populated and then manually edited. Automatically populating at least some fields of the billing region 1100 as described below may facilitate the user's task of billing a payor for a patient visit.

After the user enters an assessment code in the assessment content field 730 in assessment row 724 and the content column 710 of the patient chart region 700, which causes the microprocessor 150 (shown in FIG. 2) to receive at least one assessment code input signal representing user identification of the assessment code using at least one input device such as the display screen 104, the keyboard 106, the trackpad 108, the mouse 110 or the microphone 112, the microprocessor 150 retrieves an instance of the assessment code table entry 272 (shown in FIG. 7) stored in the database 160 in which the assessment code field 274 matches the assessment code that was entered in the assessment content field 730 in assessment row 724 and the content column 710 of the patient chart region 700. The microprocessor 150 may then automatically populate the diagnosis code field 1124 with the content of the assessment code field 274 and automatically populate the description field 1126 with the content of the assessment description field 276 of the retrieved instance of the assessment code table entry 272.

For example, if a user of the computer 102 inputs “487” in the assessment content field 730, then the microprocessor 150 retrieves an instance of the assessment code table entry 272 storing “487” in its assessment code field 274. The assessment code “487” represents influenza, so the retrieved instance of the assessment code table entry 272 stores “Influenza” in its assessment description field 276. Therefore, if the user of the computer 102 inputs “487” in the assessment content field 730, then the microprocessor 150 populates the diagnosis code field 1124 with “487” and populates the description field 1126 with “Influenza” from the assessment description field 276 of the retrieved instance of the assessment code table entry 272.

In the embodiment shown in FIG. 22, the user input “401” in the assessment content field 730 (shown FIG. 17), which caused the microprocessor 150 to retrieve an instance of the assessment code table entry 272 storing “401” in its assessment code field 274. The assessment code “401” represents essential hypertension, so the retrieved instance of the assessment code table entry 272 stores “Essential Hypertension, HTN” in its assessment description field 276. Therefore, the microprocessor 150 populated the diagnosis code field 1124 with “401” and populated the description field 1126 with “Essential Hypertension, HTN” from the assessment description field 276 of the retrieved instance of the assessment code table entry 272.

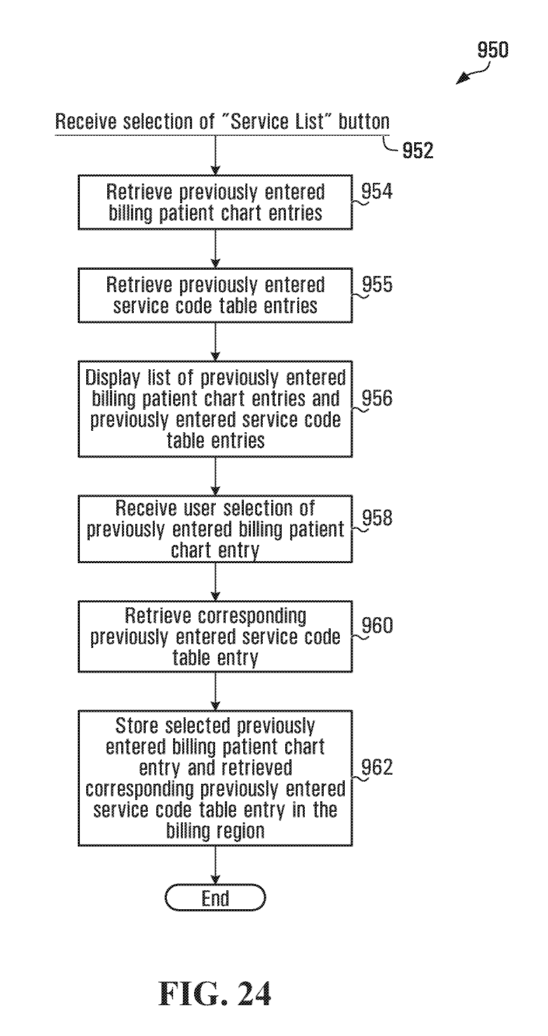

After the microprocessor 150 populates the diagnosis code field 1124 and the description field 1126, the user may select a “Service List” button 1138, which causes the microprocessor 150 to execute service list program codes shown generally at 950 in FIG. 24 that are stored in the program memory 156 (shown in FIG. 2) and that direct the microprocessor 150 to retrieve a plurality of previously entered billing patient chart entries stored in the database 160 (shown in FIGS. 2 and 3) in association with the assessment code in the diagnosis code field 1124, in association with the payor selected via the payor selector 1136, and in association with the user.

Referring to FIG. 24, the service list program codes 950 begin at 952 in response to receiving signals indicating user selection of the “Service List” button 1138. The service list program codes 950 then proceed to block 954, which includes codes for causing the microprocessor 150 to retrieve a plurality of previously entered billing patient chart entries from the database 160. Specifically, the codes at block 954 direct the microprocessor 150 to retrieve, from the billing table 480, a plurality of instances of the billing table entry 482 that are associated with the assessment code entered in the diagnosis code field 1124 (namely, instances of the billing table entry 482 in which the assessment code field 488 stores an assessment code matching the assessment code in the diagnosis code field 1124), associated with the payor selected using the payor selector 1136 (namely, instances of the billing table entry 482 in which the payor identification field 486 stores a payor matching the payor selected using the payor selector 1136), and associated with the current user (namely, instances of the billing table entry 482 in which the user identifier field 492 stores a user identified matching the user identifier of the current user).

Because the codes at block 954 direct the microprocessor 150 to retrieve, from the database 160, a plurality of previously entered billing patient chart entries that are associated with the current user, different users may, using the previously entered billing patient chart entries, associate identical service codes with different assessment codes. For example, one user may associate the service code “00100” (a service code identifying an in-office visit for patients aged 2 to 49) with the assessment code “311” (an ICD-9 code identifying depression), while a second user may associate the service code “00120” (a service code identifying an in-office individual counseling for patients aged 2 to 49) with the same assessment code “311” for example if the second user has a practice involving counseling patients diagnosed with depression. Therefore, embodiments such as those described herein may allow each user to access a personalized collection or library of previously entered billing patient chart entries for a particular assessment code, which may associate a service code with a different assessment code than another user. Such a personalized collection or library of previously entered billing patient chart entries may facilitate efficient and intuitive electronic billing of visits of patients by enabling the user to re-use an electronically stored personal set of preferred billing practices.

In alternative embodiments, association with the current user may not be required, and in such embodiments, the codes at block 954 may simply direct the microprocessor 150 to retrieve, from the database 160, a plurality of previously entered billing patient chart entries that are associated with the assessment code in the diagnosis code field 1124 (shown in FIG. 22) and with the payor selected using the payor selector 1136.

In still other embodiments, association with the selected payor may not be required, and in such embodiments, the codes at block 954 may simply direct the microprocessor 150 to retrieve, from the database 160, a plurality of previously entered billing patient chart entries that are associated with the assessment code in the diagnosis code field 1124 (shown in FIG. 22), or that are associated with the assessment code in the diagnosis code field 1124 and with the current user.

The service list program codes 950 then proceed to block 955, which includes codes for causing the microprocessor 150 to retrieve, for each one of the plurality of previously entered billing table entries retrieved at block 954, a respective instance of the service code table entry 462 in the service code table 460 in which the service code stored in the service code field 464 matches the service code stored in the service code field 490 of the one of the plurality of previously entered billing table entries retrieved at block 954.

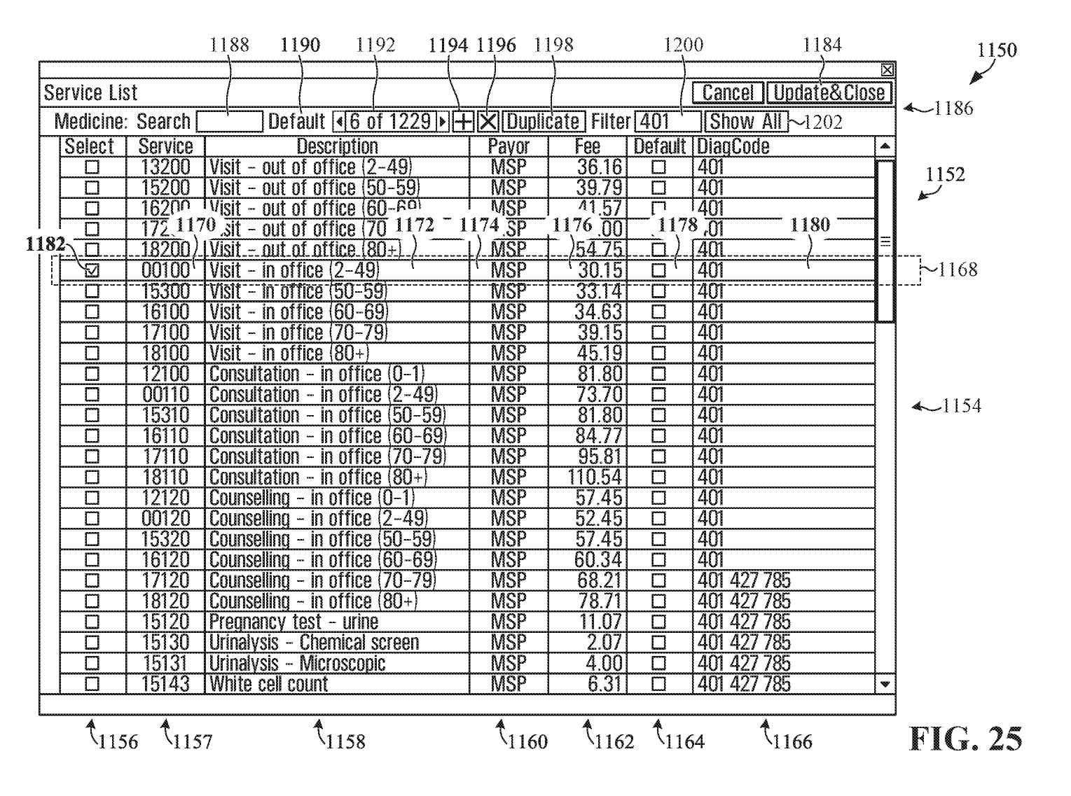

The service list program codes 950 then continue to block 956, which includes codes for directing the microprocessor 150 to display the previously entered billing patient chart entries that were retrieved at block 954, each with information from the respective service code table entry that was retrieved at block 955. The codes at block 956 further direct the microprocessor 150 to cause the display screen 104 to display a service list page shown generally at 1150 in FIG. 25. Referring to FIG. 25, the service list page 1150 includes a list region 1152, which displays the previously entered patient chart entries that were retrieved at block 954 in respective rows in a plurality of rows shown generally at 1154. The list region 1152 includes a “Select” column 1156, a “Service Code” column 1157, a “Description” column 1158, a “Payor” column 1160, a “Fee” column 1162, a “Default” column 1164, and a “DiagCode” column 1166.

The content displayed in the “Service Code” column 1157 of a row is retrieved from the service code field 490 (shown in FIG. 12) of the instance of the billing table entry 482 represented by the row. The content displayed in the “Description” column 1158 of a row in the list region 1152 is retrieved from the service description field 466 (shown in FIG. 11) of the instance of the service code table entry 462 retrieved at block 955 and having a service code stored in the service code field 464 matching the service code stored in the service code field 490 of the instance of billing table entry 482 represented by that row. Similarly, the content stored in the “Fee” column 1162 of a row in the list region 1152 is retrieved from the fees field 468 of the instance of the service code table entry 462 retrieved at block 955 and having a service code stored in the service code field 464 matching the service code stored in the service code field 490 of the instance of the billing table entry 482 represented by that row.

The content displayed in the “Payor” column 1160 of a row in the list region 1152 is retrieved from the payor identification field 486 of the instance of the billing table entry 482 represented by that row. The content displayed in the “Default” column 1164 of a row in the list region 1152 is retrieved from the default field 494 of the instance of the billing table entry 482 represented by the row. For example, in the embodiment shown, if the instance of the billing table entry 482 stores “TRUE” in the default field 494, a row representing that instance will display a check in its “Default” column 1164 and will appear above non-defaults in the list region 1152. The content displayed in the “DiagCode” column 1166 of a row in the list region 1152 is retrieved from the assessment code field 488 of the instance of the billing table entry 482 represented by that row.

For example, in the embodiment shown in FIG. 25, a row 1168 represents an instance of the billing table entry 482 (shown in FIG. 12) and includes a service code field 1170 (in the “Service Code” column 1157) indicating “00100”, which is a previously entered billing patient chart entry stored in the service code field 490 (shown in FIG. 12) of the instance of the billing table entry 482 represented by the row 1168. Row 1168 also includes a service description field 1172 (in the “Description” column 1158) indicating “Visit—in office (0-49)” and a fee field 1176 (in the “Fee” column 1162) indicating “30.15”. The “Visit—in office (0-49)” and “30.15” represent, respectively, the content stored in the service description field 466 and the fees field 468 of the instance of the service code table entry 462 (shown in FIG. 11 and retrieved at block 955) in which the service code field 464 stores the same service code as is indicated in the service code field 1170, namely “00100”.

The row 1168 also includes a “Payor” field 1174 (in the “Payor” column 1160) indicating “MSP”, which is the payor stored in the payor identification field 486 (shown in FIG. 12) of the instance of the billing table entry 482 represented by the row 1168. The row 1168 also includes a default field 1178 (in the “Default” column 1164) indicating “FALSE” from the content stored in the default field 494 of the instance of the billing table entry 482 represented by the row 1168. However, the user may select the default field 1178 to indicate that the instance of the billing table entry 482 represented by the row 1168 is a default. Therefore, user selection of the default field 1178 causes the default field 494 of the instance of the billing table entry 482 represented by the row 1168 to be set to “TRUE”, and more generally instances of the billing table entry 482 may be identified as defaults by selecting default fields in the “Default” column 1164. The row 1168 also includes an assessment code field 1180 (in the “DiagCode” column 1166), which indicates the assessment code “401” stored in the assessment code field 488 of the instance of the billing table entry 482 represented by the row 1168.

The service list page 1150 also includes a list management region 1186 including a general search field 1188, a default button 1190, page navigator buttons 1192, an add button 1194, a delete button 1196, a duplicate button 1198, a filter field 1200, and a “Show All” button 1202. The list region 1152 initially displays instances of the billing table entry 482 associated with the assessment code in the diagnosis code field 1124 (shown in FIG. 22), associated with the current user, and associated with the payor selected with the payor selector 1136 and also displays corresponding instances of the service code table entry 462 associated with the instances of the billing table entry 482 in the same rows. However, the user can also specify different criteria for identification of instances of the billing table entry 482 to be displayed in the list region 1152 (and consequently, different corresponding instances of the service code table entry 462). For example, the user can input text or other information into the general search field 1188 to search for content stored in any of the fields of instances of the billing table entry 482 and in any of the fields of instances of the service code table entry 462. The user can use the default button 1190 to cause the list region 1152 to display only instances of the billing table entry 482 that store “TRUE” in their default field 494. Also, the filter field 1200 initially indicates the assessment code that was used at block 954 (shown in FIG. 24) to retrieve the plurality of previously entered patient chart entries from the database 160 (shown in FIGS. 2 and 3), but the user can enter a different assessment code in the filter field 1200 to cause the microprocessor 150 to display instead a different plurality of instances of the billing table entry 482 stored in the database 160 in association with the different assessment code and consequently a different plurality of corresponding instances of the service table entry 462 stored in association with each of the different plurality of instances of the billing table entry 482. The user can also select the “Show All” button 1202 to cause the microprocessor 150 to display representations of all instances of the billing table entry 482, or of all instances of the billing table entry 482 that are associated with the current user. Additionally, the user can cause the DBMS codes 159 to create a new instance of the billing table entry 482 or a new instance of the service code table entry 462 by selecting the add button 1194, delete an existing instance of the billing table entry 482 by selecting the row representing the existing instance in the “Select” column 1156 and then selecting the delete button 1196, or duplicate an existing instance of the billing table entry 482 by selecting the existing instance in the “Select” column 1156 and then selecting the duplicate button 1198. The user can also use the page navigator buttons 1192 to scroll through different pages of the rows 1154.

The user may select one or more previously entered billing patient chart entries by selecting one or more of the fields in the “Select” column 1156. Selection of one or more of the rows 1154 involves selection of one or more of the service codes in the selected one or more of the rows 1154, and selection of one or more service codes may be a part of charting a patient visit, so the service codes are thus billing patient chart entries or more generally patient chart entries.

The service list page 1150 also includes an “Update & Close” button 1184. After the user selects one or more of the rows 1154, selection of the “Update & Close” button 1184 causes the one or more previously entered billing patient chart entries represented by the selected one or more of the rows 1154 to be copied to respective rows for billing patient chart entries in the billing region 1100 to populate the billing region 1100 automatically as shown in FIG. 22 for example. Specifically, each of the selected one or more of the rows 1154 is associated with a respective instance of the billing table entry 482 and with a respective instance of the service code table entry 462, and selection of the “Update & Close” button 1184 directs the microprocessor 150 to proceed to blocks 958, 960, and 962 of the service list program codes 950.

The codes at block 958 direct the microprocessor 150 to receive at least one selection input signal (from one or more of the using at least one input device such as the display screen 104, the keyboard 106, the trackpad 108, the mouse 110, and the microphone 112 shown in FIG. 1) representing user selection of at least one service code, or more generally at least one previously entered billing patient chart entry. For example, in the embodiment shown in FIG. 24, the user has selected a field 1182 in the “Select” column 1156 and in the row 1168 to select the instance of the billing table entry 482 represented by the row 1168, which represents selection of the service code “00100” (representing an in-office visit by a patient aged 2 to 49). The user may select more than one previously entered billing patient chart entry and thus more than one service code. For example, a user may select both the service code “00100” (a service code representing an in-office visit for patients aged 2 to 49) and the service code “15130” (a service code representing an chemical urine test), in which case the codes at block 958 direct the microprocessor 150 to receive at least one selection input signal representing user selection of the service codes “00100” and “15130”.

After block 958, the service list program codes 950 then proceed to block 960, which includes codes for directing the microprocessor 150 to retrieve, from the service code table 460, an instance of the service code table entry 462 (shown in FIG. 11) that stores a service code in the service code field 464 that matches the selected (at block 958) service code. For example, if a user selects (at block 958) the service code “00100”, then the codes at block 960 cause the microprocessor to retrieve, from the service code table 460, an instance of the service code table entry 462 which stores the service code “00100” in the service code field 464. As another example, if the user selects the service codes “00100” and “15130”, then the codes at block 960 cause the microprocessor 150 to retrieve both an instance of the service code table entry 462 which stores the service code “00100” in the service code field 464 and an instance of the service code table entry 462 which stores the service code “15130” the service code field 464.

After block 960, the service list program codes 950 then proceed to block 962, which includes codes for directing the microprocessor 150 to populate data input fields automatically in the billing region 1100 (shown in FIG. 22). Specifically, for each selected service code, the codes at block 962 direct the microprocessor 150 to retrieve the service description from the service description field 466 of the corresponding instance of the service code table entry 462, retrieve the fee from the fees field 468 of the corresponding instance of the service code table entry 462, copy the selected service code to the service code field 1128, copy the retrieved service description to the second description field 1130, and copy the retrieved fee to the fee field 1132, as shown in FIG. 22 for example. In the embodiment shown in FIG. 22, the user selected (at block 958) the service code “00100”, which caused the microprocessor 150 to retrieve (at block 960) an instance of the service code table entry 462 (shown in FIG. 11) storing the service code “00100” in the service code field 464. The codes at block 962 then cause the microprocessor 150 to copy “100” (which is an abbreviation of “00100” for simplicity of the user interface) to the service code field 1128, copy “Visit—in office (age 2-49)” (from the service description field 466 of the retrieved instance of the service code table entry 462) to the second description field 1130, and copy “$30.15” (from the fee field 468 of the retrieved instance of the service code table entry 462) in the fee field 1132.

In some embodiments, if more than one service code is selected by the user at block 958, the microprocessor 150 may cause the billing region 1100 to contain more than one row, each representing one service. The service list program codes 950 end after block 962.

As mentioned above, in other embodiments, the contents of the billing region 1100 may be entirely populated without any user input (that is, without causing the microprocessor 150 to receive at least one user selection input signal). In some such embodiments, after the microprocessor 150 populates the diagnostic code field 1124, the microprocessor 150 may automatically retrieve at least one instance of the billing table entry 482 from the billing table 480 in which the assessment code in the assessment code field 488 matches the assessment code stored in the diagnosis code field 1124, and in which the default field 494 is “TRUE”. Any such default service codes for the assessment code stored in the diagnosis code field 1124 may then automatically appear in the billing region 1100 as described above. In other embodiments, if only one instance of the billing table entry 482 is associated with a particular assessment code, then the service code of that instance of the billing table entry 482 may automatically appear in the billing region 1100 as described above. Automatically populating the entire billing region 1100 with any such default or automatic service codes may facilitate a user's task of billing a payor for a patient visit, for example when a particular user has an established practice of billing one or more particular service codes for a particular assessment code.

Further, in some embodiments, the billing region 1100 may include one or more rows automatically generated in response to particular treatment plan patient chart entries (identified by “P” in the type column 706). For example, an assessment code “595” (an ICD-9 code identifying bladder infection) may be associated with a treatment plan patient chart entry for a urine dip test in the user's office, and such a patient chart entry may automatically add a row identifying a fee for such a test to the billing region 1100.

As mentioned above, in other embodiments, the user may (also by causing the microprocessor 150 to receive at least one manual entry input signal from one or more of the display screen 104, the keyboard 106, the trackpad 108, the mouse 110, and the microphone 112 shown in FIG. 1, for example) manually edit automatically populated information. For example, after “00100” is automatically entered in the service code field 1128, the user may (as indicated above) type or otherwise manually edit “00100” (using the one or more of the display screen 104, the keyboard 106, the trackpad 108, the mouse 110, and the microphone 112, for example) to another character sequence, such as “00120” for example. More generally, automatically entered text in any of the input fields of the billing region 1100 may be edited manually to document (or chart) a visit of a patient to enable billing of a payor for the visit. Therefore, information in each of the input fields of the billing region 1100 may be automatically entered automatically entered and then manually edited. Further, some or all of the input fields of the billing region 1100 may be manually edited by manually entering information into the input fields.

In summary, in some embodiments, a user of the computer 102 may have previously entered billing patient chart entries for various different assessment codes and for a specific payor. Allowing the user to retrieve billing patient chart entries that were previously entered in association with an assessment code may enable the user to refer to a collection or library of previously entered billing patient chart entries that are personalized for the user, and may thus facilitate the user's task of documenting a visit of a patient.

Once the user completes the patient chart region 700 (shown in FIG. 22), prints any prescriptions or other documents (such as laboratory requisitions or referral letters), and completes the billing region 1100, the user may select a “Done” button 1140, which causes the microprocessor 150 to execute end visit program codes 1000 in the program memory 156 (shown in FIG. 2), which cause the microprocessor 150 to document the visit in the database 160 (shown in FIGS. 2 and 3) and otherwise conclude the visit.

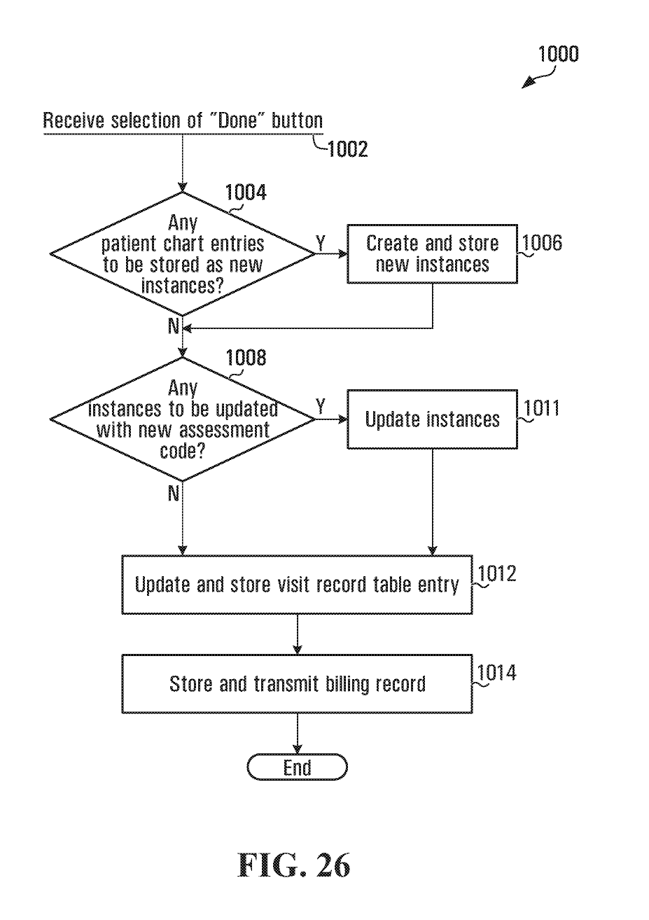

Referring to FIG. 26, the end visit program codes 1000 begin at 1002 in response to receiving signals indicating user selection of the “Done” button 1140. The end visit program codes 1000 then continue to block 1004, which includes codes for directing the microprocessor 150 to determine whether any of the patient chart entries in the patient chart region 700 and the billing region 1100 should be stored in the database 160 as new instances in the database 160 of the subjective information table entry 292 (shown in FIG. 8), of the objective data table entry 312 (shown in FIG. 9), of the treatment plan table entry 332 (shown in FIG. 10), or of the billing table entry 482 (shown in FIG. 12). Specifically, block 1004 includes codes for causing the microprocessor 150 to identify any subjective information patient chart entries (identified by “S” in the type column 706) in the patient chart region 700 having contents in the content column 710 that do not match the subjective information description field 296 of any instance of the subjective information table entry 292 in the subjective information table 290, to identify any objective data patient chart entries (identified by “O” in the type column 706) in the patient chart region 700 having contents in the content column 710 that do not match the objective data description field 316 of any instance of the objective data table entry 312 in the objective data table 310, any treatment plan patient chart entries (identified by “P” in the type column 706) in the patient chart region 700 having contents in the content column 710 that do not match the treatment plan description field 336 of any instance of the treatment plan table entry 332 or having duration information in the duration column 712 that does not match the treatment duration field 338 of any instance of the treatment plan table entry 332 in the treatment plan table 330, and any billing patient chart entries in the billing region 1100 having contents in the service code field 1128 that do not match the service code field 490 of any instance of the billing table entry 482 in the billing table 480 in which the payor identification field 486 matches the payor selected by the payor selector 1136.

If, at block 1004, any of the patient chart entries in the patient chart region 700 and the billing region 1100 should be stored as new instances in the database 160, then the end visit program codes 1000 continue to block 1006, which includes codes for directing the microprocessor 150 to create and store new instances in the database 160. Specifically, for each subjective patient chart entry (identified by “S” in the type column 706) in the patient chart region 700 having contents in the content column 710 that (at block 1004) did not match the subjective information description field 296 of any instance of the subjective information table entry 292 in the subjective information table 290, the codes at block 1006 direct the microprocessor 150 to create a new instance of the subjective information table entry 292 and to store the new instance in the subjective information table 290. In each such new instance of the subjective information table entry 292, the subjective information description field 296 stores the contents from the content column 710, the assessment code field 298 stores the assessment code from the assessment content field 730 (shown in FIG. 17), and the user identifier field 300 (shown in FIG. 8) stores an identifier of the current user.

Likewise, for each objective patient chart entry (identified by “O” in the type column 706) in the patient chart region 700 having contents in the content column 710 that (at block 1004) did not match the objective data description field 316 of any instance of the objective data table entry 312 in the objective data table 310, the codes at block 1006 direct the microprocessor 150 to create a new instance of the objective data table entry 312 and to store the new instance in the objective data table 310. In each such new instance of the objective data table entry 312, the objective data description field 316 stores the contents from the content column 710, the assessment code field 318 stores the assessment code from the assessment content field 730, and the user identifier field 320 (shown in FIG. 9) stores an identifier of the current user.

Likewise, for each treatment plan patient chart entry (identified by “P” in the type column 706) in the patient chart region 700 having contents in the content column 710 that (at block 1004) did not match the treatment plan description field 336 of any instance of the treatment plan table entry 332 or having duration information in the duration column 712 that (at block 1004) did not match the treatment duration field 338 of any instance of the treatment plan table entry 332 in the treatment plan table 330, the codes at block 1006 direct the microprocessor 150 to create a new instance of the treatment plan table entry 332 and to store the new instance in the treatment plan table 330. In each such new instance of the treatment plan table entry 332, the treatment plan description field 336 stores the contents from the content column 710, the treatment duration field 338 stores the duration information from the duration column 712, the assessment code field 340 stores the assessment code from the assessment content field 730, the user identifier field 341 stores an identifier of the current user, and the favorite field 342 is initially “FALSE” (but may be set to “TRUE” as discussed above).

Likewise, for each billing patient chart entry in the billing region 1100 having contents in the service code field 1128 that did not match the service code field 490 of any instance of the billing table entry 482, the codes at block 1006 then direct the microprocessor 150 to create a new instance of the billing table entry 482 and to store the new instance in the billing table 480. In such a new instance of the billing table entry 482, the payor identification field 486 stores the payor selected by the payor selector 1136, the assessment code field 488 stores the contents of the diagnosis code field 1124, the service code field 490 stores the contents of the service code field 1128, and the user identifier 492 stores an identifier of the current user.

In summary, the codes at block 1006 direct the microprocessor 150 to store, in the database 160, any manually entered patient chart entry that differs from each of the previously entered patient chart entries in the database 160, and over time, the codes at block 1006 cause the microprocessor 150 to store, in the database 160, previously entered patient chart entries of unrelated patients. Further, after a patient chart entry is stored in the database 160 according to the codes at block 1006, the description program codes 900 may later retrieve a plurality of previously entered patient chart entries stored in the database 160, and that plurality of previously entered patient chart entries may include the patient chart entry stored according to the codes at block 1006. In other words, the patient chart entry stored according to the codes at block 1006 is available for future patient charting

If, at block 1004, none of the patient chart entries in the patient chart region 700 or the billing region 1100 should be stored as new instances in the database 160, or after block 1006, the end visit program codes 1000 continue to block 1008, which includes codes for directing the microprocessor 150 to determine whether any instances in the database 160 of the subjective information table entry 292 (shown in FIG. 8), of the objective data table entry 312 (shown in FIG. 9), of the treatment plan table entry 332 (shown in FIG. 10), or of the billing table entry 482 (shown in FIG. 12) should be updated to be associated with a new assessment code. Specifically, block 1008 includes codes for causing the microprocessor 150 to identify any instance of the subjective information table entry 292 in the subjective information table 290 in which the subjective information description field 296 does match the contents in the content column 710 of a subjective information patient chart entry (identified by “S” in the type column 706) in the patient chart region 700 but in which the assessment code field 298 does not include the assessment code from the content column 710 of the assessment code patient chart entry (identified by “A” in the type column 706) in the patient chart region 700, to identify any instance of the objective data table entry 312 in the objective data table 310 in which the objective data description field 316 does match the contents in the content column 710 of an objective data patient chart entry (identified by “O” in the type column 706) in the patient chart region 700 but in which the assessment code field 318 does not include the assessment code from the content column 710 of the assessment code patient chart entry (identified by “A” in the type column 706) in the patient chart region 700, any instance of the treatment plan table entry 332 in the treatment plan table 330 in which the treatment plan description field 336 does match the contents in the content column 710 of a treatment plan patient chart entry (identified by “P” in the type column 706) in the patient chart region 700 and in which the treatment duration field 338 does match the duration information in the duration column 712 of the treatment plan patient chart entry (identified by “P” in the type column 706) in the patient chart region 700 but in which the assessment code field 340 does not include the assessment code from the content column 710 of the assessment code patient chart entry (identified by “A” in the type column 706) in the patient chart region 700, and any instance of the billing table entry 482 in the billing table entry table 480 in which the content of the service code field 490 does match the content of the service code field 1128 of a billing patient chart entry in the billing region 1100 and in which the payor identification field 486 matches the payor selected by the payor selector 1136, but in which the assessment code field 488 does not include the assessment code from the content of the diagnosis code field 1124 in the billing region 1100.

If, at block 1008, any of the instances should be updated to be associated with a new assessment code, then the end visit program codes 1000 continue to block 1011, which includes codes for directing the microprocessor 150 to associate the instance or instances identified at block 1008 with the new assessment code. Specifically, for each instance of the subjective information table entry 292 to be updated with the new assessment code, the codes at block 1011 direct the microprocessor 150 to update the assessment code field 298 to add the new assessment code in addition to any assessment codes that were previously stored in the assessment code field 298. Likewise, for each instance of the objective data table entry 312 to be updated with the new assessment code, the codes at block 1011 direct the microprocessor 150 to update the assessment code field 318 to add the new assessment code in addition to any assessment codes that were previously stored in the assessment code field 318. Likewise, for each instance of the treatment plan table entry 332 to be updated with the new assessment code, the codes at block 1011 direct the microprocessor 150 to update the assessment code field 340 to add the new assessment code in addition to any assessment codes that were previously stored in the assessment code field 340. Likewise, for each instance of the billing table entry 482 to be updated with the new assessment code, the codes at block 1011 direct the microprocessor 150 to update the assessment code field 488 to add the new assessment code in addition to any assessment codes that were previously stored in the assessment code field 488. As mentioned above, in some embodiments, the assessment code field 488 stores only one assessment code, and in such embodiments, rather than updating an existing instance of a billing table entry 482, a new instance of the billing table entry 482 may be created for each new assessment code. Storing only one assessment code in the assessment code field 488 may allow one instance to be a default for one assessment code and another instance not to be a default for another assessment code.

If, at block 1008, none of the instances should be updated to be associated with a new assessment code, or after block 1011, the end visit program codes 1000 continue to block 1012, which includes codes for directing the microprocessor 150 to update and the instance of the visit record table entry 352 created for the current visit by the create visit program codes 680, and to store the updated instance of the visit record table entry 352 in the visit record table 350. To update the instance of the visit record table entry 352, the codes at block 1012 direct the microprocessor 150 to copy the information from the content column 710 of each subjective information patient chart entry (identified by “S” in the type column 706) in the patient chart region 700 into the subjective information description field 400, to copy the information from the content column 710 of each objective data patient chart entry (identified by “O” in the type column 706) in the patient chart region 700 into the objective data description field 402, to copy the assessment code from the content column 710 of the assessment code patient chart entry (identified by “A” in the type column 706) in the patient chart region 700 into the assessment code field 398, to copy the information from the content column 710 of each treatment plan patient chart entry (identified by “P” in the type column 706) in the patient chart region 700 into the treatment plan description field 412, and to copy the information from the duration column 712 of each treatment plan patient chart entry (identified by “P” in the type column 706) in the patient chart region 700 into the treatment duration field 414. Additionally, to update the instance of the visit record table entry 352, the codes at block 1012 also cause the microprocessor 150 to copy the contents of the billing region 1100 into the billing field 416. Accordingly, the codes at block 1012 direct the microprocessor 150 to store the patient chart entries in the database 160 in association with the visit of the patient.

After block 1012, the end visit program codes 1000 continue to block 1014, which includes codes for directing the microprocessor 150 to transmit billing information from the billing region 1100 to the patient or to an insurance provider (for example the payor selected via the payor selector 1136), or to both. The end visit program codes 1000 end after block 1014. The billing region 1100 also includes a “Today Summary” button that, if selected, causes the display screen 104 to display a record of billings for the day if desired.

As indicated above, instead of automatic or manual entry in data input fields in the patient chart region 700 as described above, the user may prefer creating one or more subjective information patient chart entries, or one or more objective data patient chart entries, or both, using one or more patient-specific audio recordings, one or more patient-specific video recordings, or both. In such embodiments, such patient-specific recordings may be stored in the subjective information description field 400, or in the objective data description field 402, or in both (as the case may be) of the instance of the visit record table entry 352 created for the current visit by the create visit program codes 680.

In general, embodiments such as those described above may facilitate efficiently documenting a visit of a patient to a medical professional using the electronic SOAP charting method or other electronic charting methods. Embodiments such as those described above may combine some or all of: (1) input from a patient (such as demographic information or information for subjective SOAP patient chart entries, for example); (2) input from an assistant or other user (such as investigation reports, reports or other correspondence from laboratories, specialists, other clinics, or hospitals, other documentation such as government letters, reports from social workers, or pharmacy notifications, or billing reconciliations, for example); (3) input from a physician, medical professional, or other user (such as SOAP patient chart entries or billing patient chart entries, for example); or (4) automatically accumulated information (such as automatically accumulated CPP information as described above or automatically accumulated vaccination information as described above, for example). Some or all of the aforementioned information may for example be automatically entered using Microsoft™ OneNote™. Further, embodiments such as those described above may organize some or all of that information (such as patient chart entries, referrals, prescriptions, vaccinations, billing patient chart entries, investigation reports, reports or other correspondence from laboratories, specialists, other clinics, or hospitals, for example) according assessment codes (such as ICD-9 or ICD-10 codes, for example) to facilitate retrieval of such information according to such assessment codes, which may be more efficient than other methods of electronically documenting a visit.

For example, some embodiments such as those described above may permit a user to input an assessment code representing a diagnosis of the patient, and then to retrieve a plurality of previously entered patient chart entries such as a plurality of subjective observations, a plurality of objective measurements, and a plurality of treatment plans for example, all stored in association with the assessment code and in association with the user, which allows the user to access a personalized collection or library of previously entered patient chart entries for a particular assessment code. The user may then select one of the previously entered patient chart entries without manually typing or otherwise entering the same or similar patient chart entries. Additionally, some embodiments such as those described above may also permit a user to input an assessment code representing a diagnosis of a patient and then retrieve a plurality of previously entered billing patient chart entries for use in billing based on previous billing practices of the user. Further, many healthcare professionals are already familiar with assessment codes (such as ICD-9 codes, for example) to comply with billing requirements of payors for example, so storing and retrieving previously entered patient chart entries in association with assessment codes may allow for convenient retrieval of previously entered patient chart entries according to codes that a healthcare professional may already be familiar with.

Such a personalized collection or library of previously entered patient chart entries may be modified over time and may facilitate efficient and intuitive electronic documentation of, and billing for, visits of patients by enabling the user to re-use an electronically stored personal lexicon, library, or set of preferred billing practices. Some healthcare professionals may be slow typists, and retrieving previously entered patient chart entries as described above may require less typing than existing methods of electronically documenting a visit. Therefore, electronically documenting a visit according to embodiments such as those described above may be more efficient than other methods of electronically documenting a visit. Therefore, embodiments such as those described above may, when compared to existing methods of electronically documenting a visit, reduce the time that medical professionals spend electronically documenting the visit of the patient, which may allow the medical professionals to increase the number of patient visits that they can accommodate in a given period of time. Embodiments such as those described above overcome problems in other methods of electronically documenting a visit, and are therefore rooted in electronic embodiments by providing improvements over other electronic embodiments and improving how electronic embodiments interact with healthcare professionals and other users.

Additionally, embodiments such as those described above may permit a user to input an assessment code representing a diagnosis of the patient, and then to input also at least one patient chart entry such as a subjective observation patient chart entry, an objective measurement patient chart entry, a treatment plan patient chart entry, or a billing patient chart entry and automatically cause the at least one patient chart entry to be associated with the chart of the patient for the visit, and automatically cause the at least one patient chart entry to be stored for later retrieval in association with the assessment code.

Although specific embodiments have been described and illustrated, such embodiments should be considered illustrative only and not as limiting the invention as construed according to the accompanying claims.

1. A method of electronically documenting a visit of a patient, the method comprising:
causing at least one computer to receive at least one assessment code input signal representing user identification of an assessment code representing a diagnosis of the patient;
causing the at least one computer, in response to the at least one assessment code input signal, to retrieve, from at least one computer-readable medium, a first plurality of previously entered patient chart entries stored on the at least one computer-readable medium in association with the assessment code;
causing the at least one computer to display at least some of the first plurality of previously entered patient chart entries for user selection;
causing the at least one computer to receive at least one selection input signal representing user selection of at least one selected patient chart entry of the first plurality of previously entered patient chart entries; and
causing the at least one computer, in response to the at least one selection input signal, to store the at least one selected patient chart entry on the at least one computer-readable medium in association with the visit.

2. The method of claim 1 wherein the first plurality of previously entered patient chart entries are stored on the at least one computer-readable medium in association with respective user identifiers, and wherein causing the at least one computer to retrieve the first plurality of previously entered patient chart entries comprises causing the at least one computer to retrieve the first plurality of previously entered patient chart entries stored on the at least one computer-readable medium in association with the assessment code and in association with a user identifier of a current user.

3. The method of claim 1 further comprising causing the at least one computer to receive at least one manual entry input signal representing user input of at least one manually entered patient chart entry.

4. The method of claim 3 wherein the at least one manual entry input signal represents user modification of at least one of the first plurality of previously entered patient chart entries.

5. The method of claim 3 further comprising causing the at least one computer, in response to the at least one manual entry input signal, to store the at least one manually entered patient chart entry on the at least one computer-readable medium in association with the visit.

6. The method of claim 3 further comprising causing the at least one computer to store, on the at least one computer-readable medium in association with the assessment code, any of the at least one manually entered patient chart entry that differs from each of the first plurality of previously entered patient chart entries.

7. The method of claim 6 further comprising, after causing the at least one computer to store the any of the at least one manually entered patient chart entry, causing the at least one computer to retrieve, from the at least one computer-readable medium, a second plurality of previously entered patient chart entries stored on the at least one computer-readable medium in association with the assessment code, wherein the second plurality of previously entered patient chart entries comprises the any of the at least one manually entered patient chart entry.

8. The method of claim 1 wherein the first plurality of previously entered patient chart entries comprises:
a plurality of previously entered subjective information patient chart entries;
a plurality of previously entered objective data patient chart entries;
a plurality of previously entered treatment plan patient chart entries; or
a plurality of previously entered billing patient chart entries.

9. The method of claim 8 wherein the plurality of previously entered treatment plan patient chart entries comprises:
a plurality of pharmaceutical prescription chart entries, each identifying, at least, a pharmaceutical dose or a treatment duration period;
a plurality of referral treatment plan patient chart entries, each identifying, at least, a referral to a specialist, a referral to a clinic, or a referral to a hospital; or
a plurality of investigation treatment plan patient chart entries, each identifying, at least, a laboratory test or a diagnostic test.

10. The method of claim 8 wherein the plurality of previously entered billing patient chart entries each identifies, at least, a service code.

11. The method of claim 1 further comprising causing the at least one computer to display medical history information of the patient, the medical history information of the patient comprising medical history information representing at least one previously entered patient chart entry stored on the at least one computer-readable medium in association with the patient and in association with at least one medical history assessment code.

12. The method of claim 11 wherein the at least one medical history assessment code represents a recurring medical condition or a vaccination.

13. An apparatus for electronically documenting a visit of a patient, the apparatus comprising:
a means for receiving at least one assessment code input signal representing user identification of an assessment code representing a diagnosis of the patient;
a means for retrieving, in response to the at least one assessment code input signal and from at least one computer-readable medium, a plurality of previously entered patient chart entries stored on the at least one computer-readable medium in association with the assessment code;
a means for displaying at least some of the first plurality of previously entered patient chart entries for user selection;
a means for receiving at least one selection input signal representing user selection of at least one selected patient chart entry of the first plurality of previously entered patient chart entries; and
a means for storing, in response to the at least one selection input signal, the at least one selected patient chart entry on the at least one computer-readable medium in association with the visit.

14. An apparatus for electronically documenting a visit of a patient, the apparatus comprising:
a processor circuit configured to:
receive at least one assessment code input signal representing user identification of an assessment code representing a diagnosis of the patient;
in response to the at least one assessment code input signal, retrieve, from at least one computer-readable medium, a first plurality of previously entered patient chart entries stored on the at least one computer-readable medium in association with the assessment code;
cause at least one display to display at least some of the first plurality of previously entered patient chart entries for user selection;
receive at least one selection input signal representing user selection of at least one selected patient chart entry of the first plurality of previously entered patient chart entries; and
in response to the at least one selection input signal, store the at least one selected patient chart entry on the at least one computer-readable medium in association with the visit.

15. The apparatus of claim 14 further comprising the at least one computer-readable medium.

16. The apparatus of claim 15 wherein the first plurality of previously entered patient chart entries comprises a plurality of character sequences stored on the at least one computer-readable medium in association with the assessment code.

17. The apparatus of claim 15 wherein the first plurality of previously entered patient chart entries are stored on the at least one computer-readable medium independently of any patient identifier.

18. The apparatus of claim 15 wherein the first plurality of previously entered patient chart entries are stored on the at least one computer-readable medium in association with respective user identifiers, and wherein the processor circuit is configured to, in response to the at least one assessment code input signal, retrieve the first plurality of previously entered patient chart entries in association with the assessment code and in association with a user identifier of a current user.

19. The apparatus of claim 14 wherein the assessment code comprises a numerical code.

20. The apparatus of claim 14 wherein the processor circuit is further configured to receive at least one manual entry input signal representing user input of at least one manually entered patient chart entry.

21. The apparatus of claim 20 wherein the at least one manual entry input signal represents user modification of at least one of the first plurality of previously entered patient chart entries.

22. The apparatus of claim 20 wherein the processor circuit is further configured to, in response to the at least one manual entry input signal, store the at least one manually entered patient chart entry on the at least one computer-readable medium in association with the visit.

23. The apparatus of claim 20 wherein the processor circuit is further configured to store, on the at least one computer-readable medium in association with the assessment code, any of the at least one manually entered patient chart entry that differs from each of the first plurality of previously entered patient chart entries.

24. The apparatus of claim 23 wherein the processor circuit is further configured to, after causing the at least one computer to store the any of the at least one manually entered patient chart entry, retrieve, from the at least one computer-readable medium, a second plurality of previously entered patient chart entries stored on the at least one computer-readable medium in association with the assessment code, wherein the second plurality of previously entered patient chart entries comprises the any of the at least one manually entered patient chart entry.

25. The apparatus of claim 14 wherein the first plurality of previously entered patient chart entries comprises:
a plurality of previously entered subjective information patient chart entries;
a plurality of previously entered objective data patient chart entries;
a plurality of previously entered treatment plan patient chart entries; or
a plurality of previously entered billing patient chart entries.

26. The apparatus of claim 25 wherein the plurality of previously entered treatment plan patient chart entries comprises:
a plurality of pharmaceutical prescription chart entries, each identifying, at least, a pharmaceutical dose or a treatment duration period;
a plurality of referral treatment plan patient chart entries, each identifying, at least, a referral to a specialist, a referral to a clinic, or a referral to a hospital; or
a plurality of investigation treatment plan patient chart entries, each identifying, at least, a laboratory test or a diagnostic test.

27. The apparatus of claim 25, wherein the plurality of previously entered billing patient chart entries each identifies, at least, a service code.

28. The apparatus of claim 14 wherein the first plurality of previously entered patient chart entries comprises patient chart entries from a plurality of unrelated patients.

29. The apparatus of claim 14 wherein the processor circuit is further configured to cause the at least one display to display medical history information of the patient, the medical history information of the patient comprising medical history information representing at least one previously entered patient chart entry stored on the at least one computer-readable medium in association with the patient and in association with at least one medical history assessment code.

30. The apparatus of claim 29 wherein the at least one medical history assessment code represents a recurring medical condition or a vaccination.
